(19) United States
(12) Patent Application Publication
(10) Pub. No.: US 2026/0230929 A1
(43) Pub. Date: Aug. 6, 2026

(54) LATENCY REDUCTION ASSOCIATED WITH UPLINK TRANSMISSION

(71) Applicant: InterDigital Patent Holdings, Inc., Wilmington, DE (US)

(72) Inventors: Tuong Duc Hoang, Montreal (CA); Paul Marinier, Brossard (CA); Ghyslain Pelletier, Montreal (CA); Faris Alfarhan, Montreal (CA); Samuli Turtinen, Ii (FI); Francois Periard, Montreal (CA)

(73) Assignee: InterDigital Patent Holdings, Inc., Wilmington, DE (US)

(21) Appl. No.: 19/043,847

(22) Filed: Feb. 3, 2025

(51) Int. Cl. H04W 28/18; H04W 72/1273; H04W 72/54

(52) U.S. Cl. CPC H04W 28/18; H04W 72/1273; H04W 72/54

(57) ABSTRACT

Systems, methods, and instrumentalities are described herein for reducing latency in uplink transmission. A device (e.g., a wireless transmit/receive unit (WTRU)) may include a processor configured to perform one or more actions. The device may receive configuration information. The configuration information may include an indication of an identifier associated with the WTRU and a set of low-latency resources. The device may determine that a condition is satisfied. The condition may be associated with low-latency resource usage. The device may select a low-latency resource from the set of low-latency resources, based on the determination that the condition is satisfied. The device may multiplex, in a bit sequence, the identifier associated with the WTRU and at least one control unit or data unit. The device may send the bit sequence in the selected low-latency resource.

### BACKGROUND

Mobile communications using wireless communication continue to evolve. A fifth generation may be referred to as 5G. A previous (legacy) generation of mobile communication for example, may be fourth generation (4G) long term evolution (LTE).

### SUMMARY

Systems, methods, and instrumentalities are described herein that may be associated with reducing latency in uplink transmissions. A device (e.g., a wireless transmit/receive unit (WTRU)) may include a processor, a memory, and/or a transceiver (e.g., a transmitter and/or receiver), where the WTRU may be configured to perform one or more of the following actions. The WTRU may receive configuration information. The configuration information may include an indication of a set of low-latency resources and of an identifier associated with the WTRU. The WTRU may determine that a condition is satisfied. The condition may be associated with low-latency resource usage. The WTRU may select a low-latency resource from the set of low-latency resources, e.g., based on the determination that the condition is satisfied. The WTRU may multiplex, in a bit sequence, the identifier associated with the WTRU and at least one control unit or data unit. The WTRU may send the bit sequence in the selected low-latency resource.

In examples, the determination that the condition is satisfied may include the WTRU being configured to determine that: the configuration information indicates that units of a message type are to be sent in the selected low-latency resource, and the at least one control unit or data unit is of the message type; a priority of the at least one control unit or data unit is above a first threshold; a remaining delay budget associated with the at least one control unit or data unit is below a second threshold; or a number of control units and data units in a buffer satisfies a third threshold.

In examples, the determination that the condition is satisfied may include the WTRU being configured to determine at least one of: at least one low-latency resource is available within a first window of time; no non-low-latency resources are available prior to a next low-latency resource; or no non-low-latency resources are available within a second window of time.

In examples, the selected low-latency resource may be associated with a reference signal. The WTRU may be configured to determine a measurement of the reference signal, and wherein the WTRU being configured to determine that the condition is satisfied may comprise the WTRU being configured to determine that the measurement of the reference signal satisfies a threshold.

In examples, the WTRU may determine a threshold based on a remaining latency budget associated with the at least one control unit or data unit. The WTRU may determine a time duration between availability of the at least one control unit or data unit and a slot associated with the selected low-latency resource. The determination that the condition is satisfied may include the WTRU being configured to determine that the time duration is less than the determined threshold.

In examples, the WTRU being configured to select the low-latency resource from the set of low-latency resources may include the WTRU being configured to: select a temporally first low-latency resource from the set of low-latency resources; or randomly select the low-latency resource from the set of low-latency resources.

In examples, the WTRU may receive a mapping between a transmission time of the bit sequence and a low-latency-response window of time. The WTRU may determine the low-latency-response window of time based on the transmission time of the bit sequence. The WTRU may monitor for a low-latency-response during the low-latency-response.

In examples, the WTRU may receive an indication of a set of non-low-latency resources. The set of non-low-latency resources may be available prior to availability of low-latency resources. The WTRU may transmit, in a non-low-latency resource in the set of non-low-latency resources, an indication that the WTRU will send the bit sequence in the selected low-latency resource.

In examples, the WTRU may receive a mapping between the set of low-latency resources and a set of non-low-latency resources. The WTRU may determine, based on the mapping, a non-low-latency resource associated with the selected low-latency resource. The WTRU may send a transmission in the non-low-latency resource. The transmission in the non-low-latency resource may implicitly indicate that the WTRU will send the bit sequence in the selected low-latency resource.

In examples, the selected low-latency resource may be a first low-latency resource. The at least one control unit or data unit may be a first at least one control unit or data unit. The WTRU may determine a time duration between availability of a second at least one control unit or data unit and a slot associated with a second low-latency resource. The WTRU may, based on a determination that the time duration is less than a threshold, send the second at least one control unit or data unit in a non-low-latency resource.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of a low-latency-resource including resources (e.g., a second resource) for control/data Tx.

FIG. 3 illustrates an example of a low-latency-resource including a first resource for preamble transmission and a second resource for control/data transmission.

FIG. 4 illustrates an association between non-low-latency and low-latency resources.

FIG. 5 illustrates a WTRU determining whether to use a low-latency resource based on the availability of a non-low-latency resource within a period.

FIG. 6 illustrates an example of low-latency-buffer status report (BSR) and low-latency delay status report (DSR) transmission in a low-latency resource.

FIG. 7 illustrates a MAC PDU for transmission of low-latency-BSR in a low-latency resource.

FIG. 8 illustrates monitoring (e.g., by a WTRU) for a response from the network in a window after transmission in a low-latency-resource.

FIG. 9 illustrates an example associated with a WTRU being configured to reduce latency in an uplink transmission, where one or more of the illustrated actions may be performed.

### DETAILED DESCRIPTION

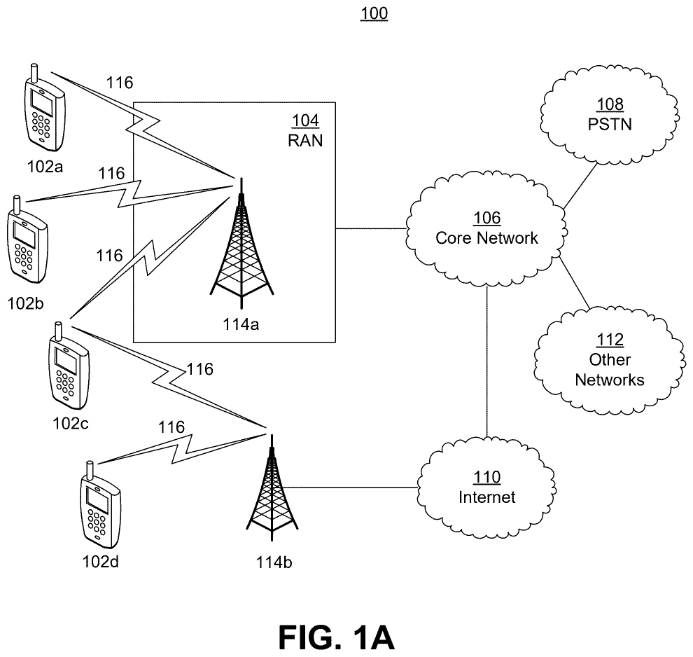

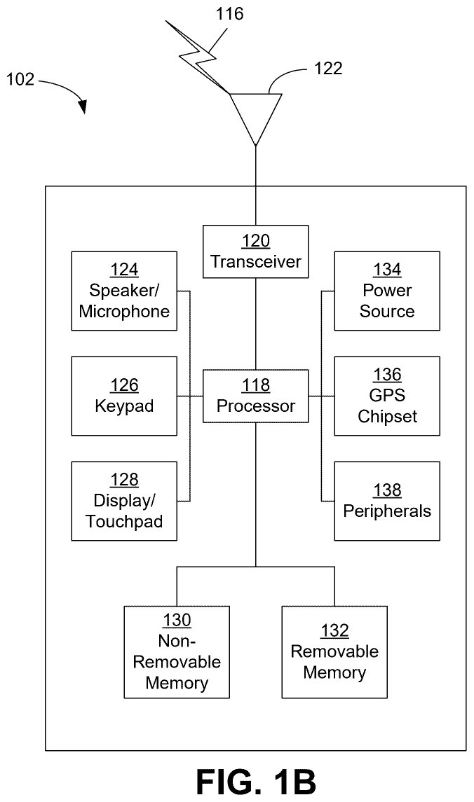

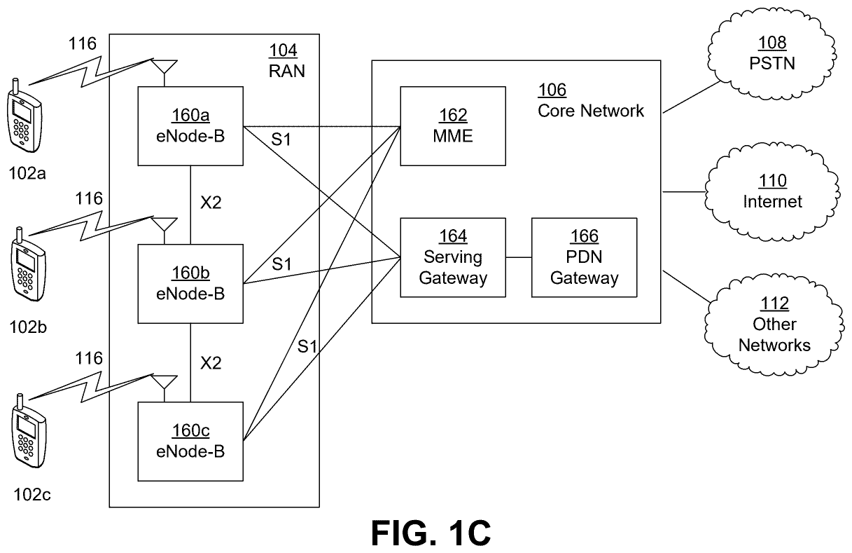

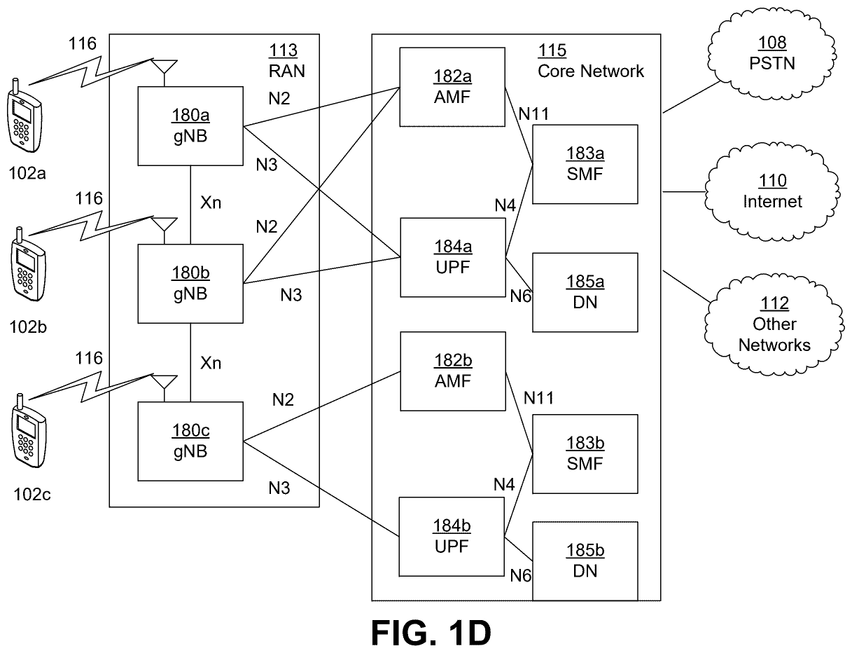

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c ). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c . For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, he emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Reference to a timer herein may refer to a time, a time period, a tracking of time, a tracking of a period of time, a combination thereof, and/or the like. Reference to a timer expiration herein may refer to determining that the time has occurred or that the period of time has expired.

Systems, methods, and instrumentalities are described herein that may be associated with reducing latency in uplink transmissions. A device (e.g., a wireless transmit/receive unit (WTRU)) may include a processor, a memory, and/or a transceiver (e.g., a transmitter and/or receiver), where the WTRU may be configured to perform one or more of the following actions. The WTRU may receive configuration information. The configuration information may include an indication of a set of low-latency resources and of an identifier associated with the WTRU. The WTRU may determine that a condition is satisfied. The condition may be associated with low-latency resource usage. The WTRU may select a low-latency resource from the set of low-latency resources, e.g., based on the determination that the condition is satisfied. The WTRU may multiplex, in a bit sequence, the identifier associated with the WTRU and at least one control unit or data unit. The WTRU may send the bit sequence in the selected low-latency resource.

In examples, the determination that the condition is satisfied may include the WTRU being configured to determine that: the configuration information indicates that units of a message type are to be sent in the selected low-latency resource, and the at least one control unit or data unit is of the message type; a priority of the at least one control unit or data unit is above a first threshold; a remaining delay budget associated with the at least one control unit or data unit is below a second threshold; or a number of control units and data units in a buffer satisfies a third threshold.

In examples, the determination that the condition is satisfied may include the WTRU being configured to determine at least one of: at least one low-latency resource is available within a first window of time; no non-low-latency resources are available prior to a next low-latency resource; or no non-low-latency resources are available within a second window of time.

In examples, the selected low-latency resource may be associated with a reference signal. The WTRU may be configured to determine a measurement of the reference signal, and wherein the WTRU being configured to determine that the condition is satisfied may comprise the WTRU being configured to determine that the measurement of the reference signal satisfies a threshold.

In examples, the WTRU may determine a threshold based on a remaining latency budget associated with the at least one control unit or data unit. The WTRU may determine a time duration between availability of the at least one control unit or data unit and a slot associated with the selected low-latency resource. The determination that the condition is satisfied may include the WTRU being configured to determine that the time duration is less than the determined threshold.

In examples, the WTRU being configured to select the low-latency resource from the set of low-latency resources may include the WTRU being configured to: select a temporally first low-latency resource from the set of low-latency resources; or randomly select the low-latency resource from the set of low-latency resources.

In examples, the WTRU may receive a mapping between a transmission time of the bit sequence and a low-latency-response window of time. The WTRU may determine the low-latency-response window of time based on the transmission time of the bit sequence. The WTRU may monitor for a low-latency-response during the low-latency-response.

In examples, the WTRU may receive an indication of a set of non-low-latency resources. The set of non-low-latency resources may be available prior to availability of low-latency resources. The WTRU may transmit, in a non-low-latency resource in the set of non-low-latency resources, an indication that the WTRU will send the bit sequence in the selected low-latency resource. p In examples, the WTRU may receive a mapping between the set of low-latency resources and a set of non-low-latency resources. The WTRU may determine, based on the mapping, a non-low-latency resource associated with the selected low-latency resource. The WTRU may send a transmission in the non-low-latency resource. The transmission in the non-low-latency resource may implicitly indicate that the WTRU will send the bit sequence in the selected low-latency resource.

In examples, the selected low-latency resource may be a first low-latency resource. The at least one control unit or data unit may be a first at least one control unit or data unit. The WTRU may determine a time duration between availability of a second at least one control unit or data unit and a slot associated with a second low-latency resource. The WTRU may, based on a determination that the time duration is less than a threshold, send the second at least one control unit or data unit in a non-low-latency resource.

Dynamic scheduling in New Radio (NR) may be provided. A dynamic scheduling procedure in NR may require a number of (e.g., two) rounds of signaling exchange between the network and the WTRU before uplink transmissions of its data in the buffer. A round (e.g., a first round) may be used for indicating the buffer status and another round (e.g., a second round) may be used for uplink transmission. If data is available in the buffer and/or there is no uplink grant for data transmission, the WTRU may need to trigger Scheduling Request (SR) to indicate to the network that it has uplink data to transmit. The network may schedule a small dynamic grant using DCI for the WTRU to transmit a buffer status report (BSR), if the SR is received from the WTRU, for example. After the BSR is transmitted, the network may be aware of the buffer status of the WTRU and schedule the uplink grant for data transmission (e.g., properly).

Small data transmission may be provided. In NR, uplink small data transmission (SDT) may be supported to enable the WTRU to send small data if still in an RRC inactive state. If the condition(s) for using SDT are met, the WTRU may send a small amount of data with the CCCH message (RRCResumeRequest). The criteria may include buffered data (e.g., all buffered data) being for SDT DRBs, the data volume (DV) being less than a threshold, RSRP being above a threshold, and resources being configured for SDT.

The WTRU may be configured with configured grant resources (CG-SDT) (by RRC signaling) and/or RA (RA-SDT) resources (by broadcast signaling) for SDT. If configured with CG-SDT and the timing advance (TA) timer associated with SDT has not expired, the WTRU may use the CG-SDT resources for SDT. The WTRU may (e.g., otherwise) use the RA-SDT resources for SDT.

Two-step RA may be used for small data transmission. A two-step RACH procedure is a contention-based procedure in which the WTRU may transmit MsgA (PRACH+MsgA-PUSCH) and/or wait for MsgB (RAR+Contention Resolution). For MsgA, the WTRU may (e.g., first) transmit PRACH and/or transmit (e.g., subsequently) MsgA-PUSCH. The MsgA-PUSCH may be mapped to the selected PRACH. The WTRU may use MsgA-PUSCH to transmit data to the network. Using RA-SDT may require one round of signaling to transmit data to the network.

The conventional dynamic scheduling procedure may require a delay (e.g., a long delay) before the WTRU is able to perform uplink transmission of its data in the buffer, which may not be suitable for delay critical data. Using a configured grant with small periodicity may help fulfill the delay requirement. Using a configured grant may result in spectrum inefficiency because the configured grant may be dedicated to the WTRU and/or the WTRU may not necessarily use the resource in all periods. The unused resource(s) may be wasted. More resources may be wasted for a configured grant with shorter periodicity.

A WTRU may trigger transmission of a set of control/data units allowed and/or indicated to be transmitted in a low-latency resource based on triggering condition(s) for transmission in a low-latency resource being satisfied. A WTRU may perform one or more of the following actions (e.g., may be configured to perform one or more of the following actions).

The WTRU may receive configuration information (e.g., the WTRU may be configured via the configuration information). The configuration information may include or indicate one or more of the following. The configuration information may include or indicate a set of resources for uplink transmission (e.g., low-latency resources). The configuration information may include or indicate an ID (e.g., C-RNTI, WTRU ID) to transmit in a low-latency resource.

The configuration information may include or indicate a set of control (e.g., UCI, MAC-CE format) and/or data (e.g., DRBs/LCHs) unit(s) to transmit in the low-latency resource, for example. The set of control and/or data units may include a UCI to indicate and/or report the HARQ feedback, SR. The set of control and/or data units may include an MAC-CE to report BSR, a delay status report (DSR), power headroom (PHR), and/or HARQ feedback. The set of control and/or data units may include data associated with a set of LCH(s) and/or DRB(s).

The configuration information may include or indicate one or more conditions to transmit a control unit in a low-latency resource, for example. A condition to transmit a control unit in a low-latency resource may include the WTRU having a BSR to report data in a configured set of LCGs. A condition to transmit a control unit in a low-latency resource may include the WTRU having a DSR to report data with remaining latency being less than a threshold.

The configuration information may include or indicate one or more conditions to transmit a data unit in a low-latency resource, for example. The one or more conditions to transmit a data unit in a low-latency resource may include a priority (e.g., importance parameter) of the data unit being greater a threshold. The one or more conditions to transmit a data unit in a low-latency resource may include a remaining latency budget of the data unit being less than a threshold.

The WTRU may determine that one or more of the configured conditions for using a low-latency resource are met. For example, a configured condition for using a low-latency resource being met may include that a UCI/MAC-CE for reporting HARQ feedback is available and/or that CSI is available. A configured condition for using a low-latency resource may include that a BSR for reporting associated with a set configured LCHs/LCGs (e.g., high priority data) is available. A configured condition for using a low-latency resource may include that a DSR for reporting data has a remaining latency that is smaller than a threshold is available. A configured condition for using a low-latency resource may include that delay-critical and/or high-priority data is available.

The WTRU may select a (e.g., one) low-latency resource for transmission. The WTRU may select the first low-latency resource for transmission (e.g., the first (e.g., temporally) low-latency resource in the set of low-latency resources, for example the low-latency resource in the set that is associated with an earliest available time). The WTRU may randomly select one low-latency resource within a configured window for transmission.

The WTRU may multiplex the configured ID and/or the allowed control and/or data units in a bit-sequence and/or transmit the configured ID and/or the allowed control and/or data units (e.g., the multiplexed configured ID and the allowed control and/or data units) in the selected low-latency resource.

One or more features described herein may enable a WTRU to reduce latency in transmission of control units and/or data units (e.g., control/data, control/data units, etc.) as the WTRU may use a low-latency resource directly without waiting for multiple rounds of signaling for SR/BSR. Spectrum efficiency of the system may be improved.

The term “network” may be used to describe the base station serving the WTRU, a gNB, a 6G gNB, a TRP, a network entity such as LMF, a coordinator device (e.g., a relay WTRU, another WTRU, a group coordinator). Sidelink communications may be provided. The features described herein may be applicable for sidelink communications, where actions described as being performed by a network may be replaced by another node (e.g., a sidelink device, a relay, etc.). A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving an RS (e.g., such as CSI-RS) or a SS block. The WTRU transmission may be referred to as “target”. The received RS or SS block may be referred to as “reference” or “source”. The WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by RRC or signaled by MAC CE or DCI. For example, a WTRU may implicitly transmit PUSCH and DM-RS of PUSCH according to the same spatial domain filter as an SRS indicated by an SRS resource indicator (SRI) indicated in DCI or configured by RRC. In another example, a spatial relation may be configured by RRC for an SRI or signaled by MAC CE for a PUCCH. Such spatial relation may be referred to as a “beam indication.”

The WTRU may receive a first (e.g., a target) downlink channel or signal according to the same spatial domain filter or spatial reception parameter as a second (e.g., a reference) downlink channel or signal. For example, such association may exist between a physical channel such as PDCCH or PDSCH and its respective DM-RS. At least if the first and second signals are reference signals, such association may exist if the WTRU is configured with a quasi-colocation (QCL) assumption type D between corresponding antenna ports. Such association may be configured as a transmission configuration indicator (TCI) state. A WTRU may receive an indication of an association between a CSI-RS or SS block and a DM-RS by an index to a set of TCI states configured by RRC and/or signaled by MAC CE. Such indication may be referred to as a “beam indication”. RS may be interchangeably used with one or more of RS resource(s), RS resource set(s), RS port(s) and RS port group(s). RS may be interchangeably used with one or more of SSB, CSI-RS, SRS and DM-RS.

The term “the WTRU is configured with something” may be used to indicate that the WTRU is preconfigured with something, or the WTRU may receive the network configuration of something (e.g., via configuration information). The network configuration may be received via a SIB, a dedicated RRC message, MAC CE, or DCI. For example, “the WTRU is configured with a threshold” is equivalent to “the WTRU is preconfigured (e.g., the WTRU stores the configuration) with the threshold” or “the WTRU receives, from the network, via SIB, RRC, MAC CE, and/or DCI, the threshold.”

Indication from the network and configuration from the network may be used interchangeably. Both terminologies may be used to describe the WTRU receiving the scheduling decision from the network. The WTRU may receive an indication/configuration from the network via any downlink reception such as SIB, NAS, RRC, MAC-CE, and/or DCI.

A control/data (e.g., control and/or data) unit may be used to represent, indicate, and/or describe a control unit, a data unit, or a control and/or data unit. A control and/or data unit may be a unit including a control bit and/or a data bit. A unit in a control and/or data unit may be used to represent/indicate/describe one or any combination of the granularities for control/data treatment from the WTRU and the network. One unit granularity may be one or any combination of the following: one control/data bit; one SDU (segment) in any protocol layer (e.g., SDAP/PDCP/RRC/RLC/MAC SDU (segment), MAC-CE, TB (segment), CBG, CB, UCI); a PDU (segment) in any protocol layer (e.g., a SDAP/PDCP/RRC/RLC/MAC PDU-segment); one or more subsets of a PDU set; one PDU set; multiple inter-dependent PDU sets; or a data burst.

A control unit may be used to represent, indicate, or describe a control unit in any layer (e.g., NAS, SDAP, PDCP, RLC, MAC, PHY). For example, a control unit may be associated with one or more control bits in an SRB for NAS, a RRC message, a control PDCP PDU/SDU, a control RLC PDU/SDU, a MAC CE, a UCI.

A data unit may be used to represent, indicate, or describe a data unit from user plane in any layer (e.g., NAS, SDAP, PDCP, RLC, MAC, PHY). For example, a data unit may be associated with a data bit in a QoS flow, a data bit in a DRB, a PDCP SDU/PDU, a RLC SDU/PDU, a MAC SDU/PDU, a TB (segment), a CB/CBG.

QoS associated with a control/data unit may be used to indicate or describe one or more of the following: one or more parameters (e.g., QoS) of an SDU/PDU (segment) associated with the control/data unit, in which the control/data unit may belong to the SDU/PDU (segment) or the SDU/PDU (segment) may belong to the control/data unit; one or more parameters of a PDU Set (e.g., QoS parameters) associated with the control/data unit, in which the control/data unit may belong to the PDU set or the PDU set may belong to the control/data unit; one or more parameters of a Data Burst associated with the control/data unit, which may include one or more of the following; or one or more redundancy parameters (e.g., Application Layer Forward Error Correction ratio (AL-FEC ratio) associated with the control/data unit, which may be used to indicate the number of required PDUs to decode the PDU set.

The parameters of an SDU/PDU (segment) may include one or more of the following: the SDU/PDU Importance, which may be used to indicate the importance of the PDU set associated with the PDU, the relative importance of the PDU in the PDU set, the relative importance of the PDU in a Data Burst, and/or the relative Importance of the PDU in the QoS flow; the priority associated with the SDU/PDU; the latency requirement of the SDU and/or PDU (e.g., a segment), which may include a Packet Delay Budget (PDB) or a remaining PDB; the synchronization window, which may be used to describe the synchronization requirement between two or more interdependent SDU/PDUs (e.g., to satisfy the QoS requirement of an XR service, the WTRU may need to deliver two interdependent SDU/PDUs within the synchronization window. If the first SDU/PDU is transmitted or received, the WTRU may need to transmit or receive the second inter-dependent SDU and/or PDU within the synchronization window.); the remaining synchronization window and/or the remaining time to serve (e.g., to transmit or receive) the SDU and/or PDU, which may be used to describe the remaining time to serve the second SDU/PDU if the first inter-dependent SDU/PDU is transmitted or received (e.g., due to synchronization requirement between the SDU and/or PDU and another inter-dependent SDU and/or PDU); the reliability requirement of the SDU/PDU (e.g., Packet Error Rate (PER)); the maximum Data Burst Volume (MDBV); the traffic type of the SDU/PDU (segment) (e.g., periodic vs. aperiodic); the periodicity of the PDU/PDU-segment; or the size of the PDU and/or PDU-segment.

The parameters of the PDU set may include one or more of the following: a PDU Set Importance (e.g., PSI), which may be used to indicate the relative importance of a PDU Set compared to other PDU Sets within a QoS Flow; the PDU set Priority; the (e.g., remaining) synchronization window, which may be used to describe the synchronization requirement between two or more inter-dependent PDU sets or the synchronization requirement between one PDU set and one or more other PDUs (e.g.,, to satisfy the QoE requirement of an XR service, the WTRU may need to deliver two interdependent PDU sets within the synchronization window. If the first PDU set is transmitted or received, the WTRU may need to transmit or receive the second inter-dependent PDU set within the synchronization window.); the latency requirement associated with the PDU set (e.g., the (remaining) PSDB, which may be used to indicate the maximum time between reception of the first PDU and the successful delivery of the last arrived PDU of a PDU Set); the PDU Set Integrated Handling Indication (PSIHI) indicates whether all PDUs of the PDU Set are needed for the usage of PDU Set by application layer; the type of the PDU set; or the reliability requirement of a PDU Set such as PDU Set Error Rate (PSER).

The reliability requirement of a PDU Set such as PDU Set Error Rate (PSER) may be used to indicate one or any combination of the following: the volume of the PDU set; the type of PDU set (e.g., periodic vs. aperiodic); or the periodicity of the PDU set. The volume of the PDU set may include one or more of the size of each PDU or the number of PDUs in the PDU set.

The type of the PDU set may include one or more of the first type of PDU set (e.g., which may require reliable delivery of all PDUs in the set), the second type of PDU set (e.g., in which the transmission of a PDU set may be unsuccessful if at least one (possibly specific) PDU fails transmission), and/or the third type of PDU set (e.g., in which the transmission of a PDU set may be successful if X PDUs of the PDU set of Y PDUs are received. For example, if Forward Error Correction (FEC) is used or if additional layered encoding is used and assigned to the same PDU set.).

One or more parameters of a Data Burst associated with the control/data unit may include the volume of the Data Burst. The volume of the Data Burst may include one or more of the following: the size of each PDU in the Data Burst; the number of PDU sets in the Data Burst; or the volume of each PDU set in the Data Burst.

One or more of the following may be applicable (e.g., in association with the one or more redundancy parameters). In examples, a control/data unit may be a PDU set. The receiver may need to successfully receive at least K out of N PDUs in the PDU set to successfully decode the PDU set (e.g., successfully decode a video frame at Application layer). K, or the ratio between K and N (e.g., K/N) may be used as one of the QoS parameters for the PDU set to represent the redundancy parameter for the PDU set.

In examples, a control/data unit may be a PDU set, which may include multiple subsets of the PDU set. The WTRU may be required to successfully transmit a ratio or a certain number of PDUs of each subset of the PDU set to satisfy a certain QoS requirement. The ratio of each PDU may be used as one or more QoS parameters for the PDU set to represent the redundancy parameters for the PDU set.

A QoS treatment profile may be associated with a (e.g., one) control/data unit.

An application may provide one or more IP flows for transmission over a medium. Each IP flow may go through a transport layer protocol (e.g., TCP/IP, QUIC, RTP, MOC, etc). An IP flow (e.g. each IP flow, or a PDU session) may go through a RAN core network. The RAN core network may map it to a RAN data flow or a RAN data set. For a RAN data flow (e.g., each RAN data flow), the core network may attach QoS requirements, a QoS metric, or a range of QoE metrics.

A RAN data flow may represent a logical association between data units (e.g., originating from the same IP flow). Such association may be based on such data units being associated to the same IP flow, application flow, or having the same association packet marked either by the core network or the application.

Some RAN data flows may not originate from a user application, but rather from control plane (e.g., control data and RAN signaling and configurations), an intelligence plane (e.g., data collected from AI/ML services), a computing plan (e.g., used for native computing for computing services), a system plane (e.g., data originating within the RAN, due to sensing or positioning services), and/or a security plane.

The WTRU may assign a QoS class to each control/data unit within a RAN data flow for the purpose of characterization of how control/data should be transmitted. A protocol plane may contain a control/data unit classification function for QoS class marking throughout the protocol chain. The QoS class may be determined in such a layer according to one or more configured or predefined rule. Such QoS class may be used in various layers within the data plan protocol chain for achieving a certain QoS requirement. A QoS class (e.g., each QoS class) may be associated with a QoS treatment profile in the RAN, which may be configured semi-statically or change dynamically. A QoS treatment profile (e.g., each QoS treatment profile) may contain a number of parameters to control the RAN treatment of the data transmission and/or reception and a number of metrics to achieve the QoS and/or QoE level for a given layer in the protocol chain. A QoS class or QoS treatment profile (e.g., each QoS class or QoS treatment profile) may be associated and/or configured with one or more QoS parameters (e.g., a priority, an importance level, a delay bound, a reliability level, a guaranteed bit rate, a maximum bit rate, and/or a maximum packet loss rate).

QoS, QoS class, and/or QoS treatment profile may be provided. A QoS, QoS class, and QoS and QoS treatment profile associated with a control/data unit may be used interchangeably. Delay-critical control/data may be used to indicate the control/data having the (e.g., remaining) delay budget being smaller than a configured threshold. high importance control/data may be used to indicate the control/data associated with a QoS and/or QoS treatment profile having the importance being greater than a configured threshold. A high priority control/data may be used to indicate the control/data associated with a QoS and/or QoS treatment profile having the priority being greater than a configured threshold.

Low-latency resource may be used to indicate the resource shared among two or more WTRUs. Low-latency resource may be used to indicate the resource requiring contention-based transmission. Low-latency resource and contention-based resource may be used interchangeably. Non-low-latency resource may be used to indicate the resource dedicated for the WTRU. Non-low-latency resource may enable the WTRU to perform non-low-latency transmission. In the disclosure, non-low-latency resource, non-low-latency resource, dedicated resource, and/or WTRU-dedicated resource may be used interchangeably. In examples, feature(s) described herein associated with a low-latency resource may be used for a non-low-latency resource and vice versa.

Methods for configuration of low-latency transmission may be provided. The WTRU may be configured, indicated, or scheduled with a set of resources for uplink transmission. The WTRU may receive an indication whether the set of resources is low-latency one or non-low-latency one. The low-latency resource may be shared among multiple WTRUs. The WTRU may be configured to perform contention-based transmission in a low-latency resource. The non-low-latency resource may be dedicated for the WTRU. The WTRU may perform contention-free resource in a non-low-latency resource.

The WTRU may be configured with a low-latency resource. The WTRU may be configured with and/or dynamically indicated with a set of low-latency resources for uplink transmission. The set of resource may be periodic and/or aperiodic. A low-latency resource (e.g., each low-latency resource) may include one or any combination of the following resources: one or multiple first resources, or one or multiple second resources. A first resource (e.g., each first resource) may be used for transmission of a preamble (e.g., using PRACH channel). The first resource may be used for the network to determine whether there is a potential control/data transmission in the future. The transmission in the first resource may be used for the network to be estimate the timing advance (TA) associated with the transmission in an associated second resource. A second resource (e.g., each second resource) may be used for the WTRU to transmit control/data. A second resource (e.g., each second resource) may be used to transmit PUCCH, PUSCH, and/or a new channel enabling sharing among multiple WTRUs (e.g., NOMA-based channel).

The WTRU may be configured and/or scheduled with a set of low-latency resources, in which each low-latency resource may include one or more first resources (e.g., to transmit preamble) and one or more second resources (e.g., to transmit control/data). The WTRU may be configured and/or scheduled with a set of low-latency resources, in which each low-latency resource may include the second resources (e.g., to transmit control/data, only).

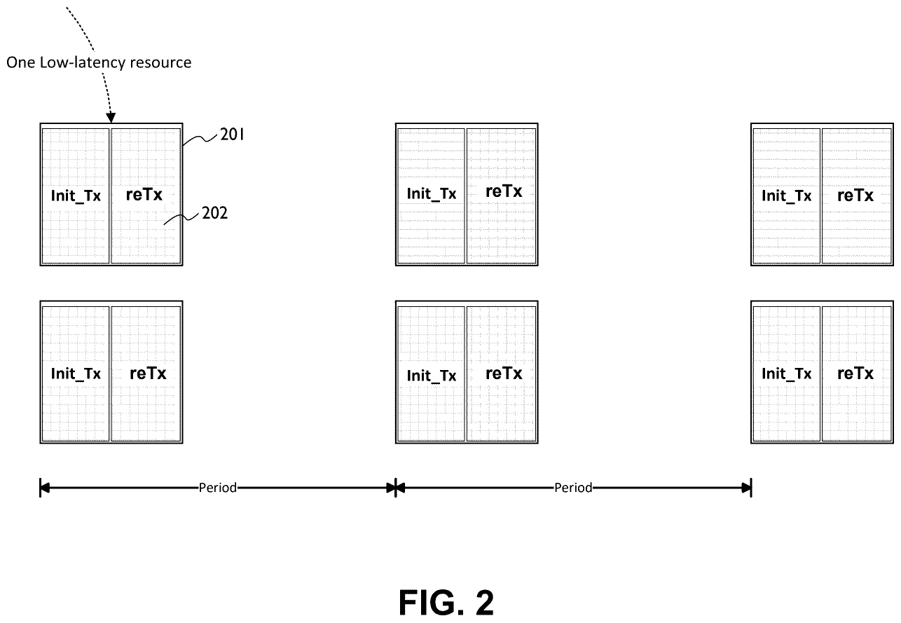

FIG. 2 illustrates an example of a low-latency-resource including resources (e.g., a second resource) for control/data Tx. In an example shown in FIG. 2, the WTRU may be configured and/or scheduled with a set of periodic low-latency resources, in which each low-latency resource 201 may include one or multiple (e.g., two) second resources 202 for control/data transmission. Each low-latency resource may be used for initial transmission and/or retransmissions of one or more control/data units (e.g., one resource for initial transmission and another resource for retransmission of a TB). The resources in one low-latency resource may be contiguous and/or non-contiguous. In each period, the WTRU may be configured/indicated/scheduled with multiple low-latency resources (e.g., two). The WTRU may select one low-latency resource for its transmission, which may be selected randomly or based on the QoS/QoS (e.g., QoS and/or QoS-treatment profile) treatment profile associated with the control/data unit.

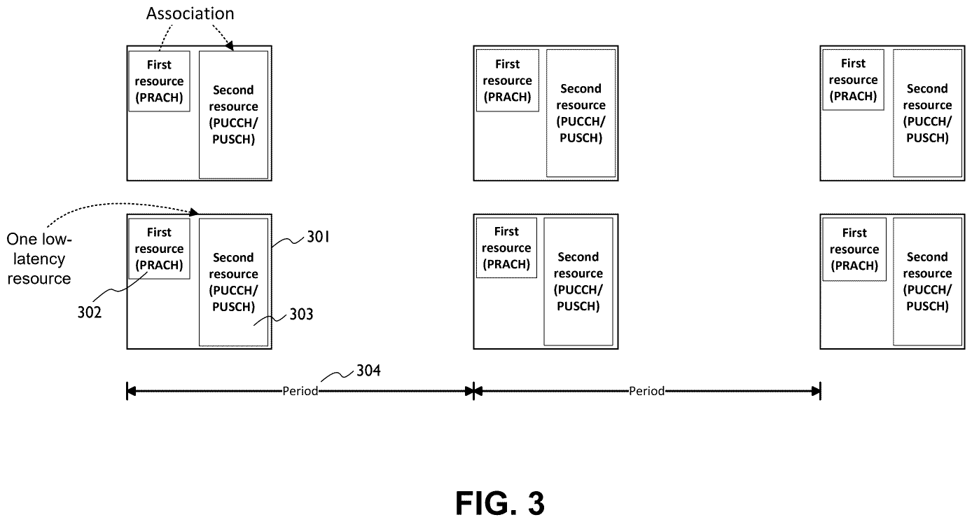

FIG. 3 illustrates an example of a low-latency-resource including a first resource for preamble transmission and/or a second resource for control/data transmission. In another example shown in FIG. 3, the WTRU may be configured/scheduled with a set of periodic low-latency resources, in which a low-latency resource 301 (e.g., each low-latency resource 301) may include one and/or multiple first resources 302 for preamble transmission and one and/or multiple second resources 303 for control/data transmission. A low-latency resource 301 (e.g., each low-latency resource 301) may be used for initial transmission, and/or retransmissions of one or more control/data units (e.g., one or multiple TBs, one or multiple UCI). In a period 304 (e.g., each period 304), the WTRU may be configured and/or scheduled with multiple low-latency resources 301. The WTRU may select one low-latency resource 301 for its transmission, which may be selected randomly or based on the QoS and/or QoS treatment profile associated with the control/data unit.

The WTRU may be configured and/or scheduled with a mapping of the first and/or the second resources. The WTRU may be configured and/or scheduled with a set of low-latency resources, in which each low-latency resource may include two resources (e.g., the first resource and the second resource). The WTRU may be configured with a mapping and/or an association between one and/or multiple first resource and one and/or multiple second resource. The WTRU may select one first resource to transmit a preamble. The WTRU may transmit control/data in one of the second resources associated with the first resource. The WTRU may select one second resource for transmission of control/data. The WTRU may select one of the associated first resources to transmit a preamble.

The WTRU may use a non-low-latency resource to indicate the usage of low-latency resources. The WTRU may be configured and/or scheduled with a set of non-low-latency resources (e.g., WTRU-dedicated resource), which may be before and/or after a set of low-latency resources. A non-low-latency resource (e.g., each non-low-latency resource) may be used to implicitly or explicitly indicate one or any combination of the following information regarding the usage of low-latency resources: an indication (e.g., SR) to the network that it may use a low-latency resource for uplink transmission; the WTRU identity (e.g., WTRU ID, C-RNTI); or the low-latency resource(s) used/to-be-used for its transmission.

In examples, the WTRU may be configured and/or scheduled with a set of resources (e.g., periodic PUCCH to transmit SR) before a window of low-latency resources. The WTRU may transmit in a non-low-latency resource to implicitly or explicitly indicate that it may use one of the low-latency resource in the associated window of low-latency resources. In one example, by transmission in a non-low-latency (e.g., WTRU dedicated) resource, the WTRU may implicitly provide the WTRU identity to the network to indicate the network it is using one or more low-latency resource in an associated window of low-latency resources. In examples, the WTRU may transmit in a non-low-latency resource to indicate which resource it may use and/or has used for low-latency transmission. The network may determine (e.g., know) the identity of the WTRU transmitting in a low-latency resource.

The WTRU may be configured and/or scheduled with a resource to indicate the transmission in a low-latency resource. The WTRU may be configured and/or scheduled with an association between a non-low-latency resource (e.g., each low-latency resource, a PUCCH for SR for example) and a set of low-latency resources. In examples, a non-low latency resource (e.g., each non-low-latency resource) may be associated with a set of low-latency resources within a window. The network may assume that the WTRU may transmit control data in one or more of the associated low-latency resources (e.g., in an associated transmission window) if the non-low-latency (e.g., SR in PUCCH) is received from a WTRU. The network may avoid and/or reduce blind detection of low-latency transmissions.

The WTRU may be configured to determine which information to convey in the non-low-latency transmission, which is associated with one or more low-latency resources. The WTRU may be configured and/or scheduled with an association between a non-low-latency resource (e.g., each non-low-latency resource, a PUCCH for SR) and low-latency resources. The WTRU may perform transmission in the non-low-latency resource, which may be used to support the network in reception of the associated low-latency transmission. The WTRU may indicate one or more of the following information in the transmission. The WTRU may indicate the parameters associated with the transmission in the associated low-latency resources such as QoS and/or QoS treatment profile of the control/data to be transmitted in the low-latency resource (e.g., the priority of the MAC-CE). The WTRU may indicate the parameter used to decode the low-latency transmission. In examples, the WTRU may implicitly or explicitly indicate the scramble ID (e.g., WTRU ID) for the network to decode the low-latency transmission in the non-low-latency transmission. The WTRU may indicate the low-latency resource to be transmitted. In examples, the WTRU may use the transmission in the non-low-latency resource to indicate which associated low-latency resource it may use for transmission.

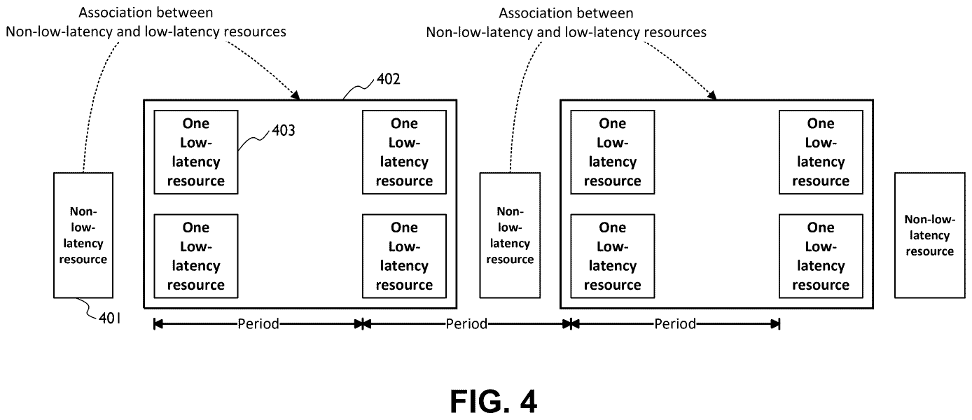

FIG. 4 illustrates an association between non-low-latency and low-latency resources. In an example shown in FIG. 4, the WTRU may be configured and/or scheduled with a periodic non-low-latency resource(s) 401, in which a non-low-latency resource 401 (e.g., each non-low-latency resource) may be associated with a window 402 of low-latency resources 403. The window may include the low-latency resources in one and/or multiple periods (e.g., two). The WTRU may transmit in a non-low-latency resource 401(e.g., SR in PUCCH). Based on the transmitted non-low-latency resource 401, the WTRU may select one of the associated low-latency resources 403 to transmit control/data.

The WTRU may be configured and/or scheduled with multiple low-latency-resources with different properties. The WTRU may be configured and/or scheduled with multiple low-latency-resources, in which a non-low-latency resource (e.g., each low-latency-resource) may be differentiated from another by one or any combination of the following: the preamble index; the time-frequency resource for a transmission (e.g., each transmission, the first and/or second resource); the DMRS port; the transmission beam (e.g., SRI); or the associated reference signal (e.g., CSI-RS, SSB).

In examples, the WTRU may be configured and/or scheduled with multiple first resources for low-latency transmission, in which a resource (e.g., each resource) may be associated with a (e.g., one) preamble index. In examples, the WTRU may be configured and/or scheduled with multiple low-latency resources, in which each low-latency resource may be differentiated from each other by the time-frequence of the first and/or the second resource. In examples, the WTRU may be configured and/or scheduled with multiple low-latency resource, in which a resource (e.g., each resource) may be differentiated from each other by the DMRS-port used for the second resource. In examples, the WTRU may be configured and/or scheduled with multiple low-latency resource, in which a resource (e.g., each resource) may be associated with one transmission beam (e.g., SRI). In examples, the WTRU may be configured and/or scheduled with multiple low-latency resource, in which a resource (e.g., each resource) may be associated with one received reference signal (e.g., SCI-RS, SSB).

Methods for reporting traffic information to the network may be provided. A WTRU may indicate its traffic information to the network. The WTRU may be configured to indicate and/or report its traffic information (e.g., SR/BSR/DSR/MAC-CE) to the network. The WTRU may implicitly or explicitly indicate one or any combination of the following traffic information to the network.

The WTRU may indicate the type of data in the buffer. The WTRU may indicate whether the traffic is associated with a normal user data. The WTRU may indicate whether the data is associated with sensing data, AI/ML data, etc.

The WTRU may indicate the QoS/QoS treatment profile associated with the reported control/data. In examples, the WTRU may report the importance, priority, (remaining) delay budget associated with the reported control/data.

The WTRU may indicate the amount and/or availability of control/data unit satisfying and/or not-satisfying a configured condition (e.g., delay critical, high importance, and/or high priority control/data) and potentially its associated QoS parameters (e.g., the (remaining) delay budget, the priority, the importance).

In examples, the WTRU may report the amount of delay critical, high importance, and/or high priority control/data associated with each QoS treatment profile (e.g., RB/LCH/LCG). Such report may be similar to BSR/DSR.

In examples, the WTRU may report the amount of delay critical/non-delay critical, high importance, non-high importance, and/or high priority/non-high priority control/data associated with each QoS treatment profile (e.g., RB/LCH/LCG).

The WTRU may indicate the amount and/or availability of control/data units and potentially its associated QoS value satisfying/not-satisfying a configured condition, which may be available, not available, and/or to-be-available within a period at the buffer. In examples, the WTRU may report the amount/availability of the delay critical, high priority, and/or high importance control/data to-be-available in its buffer within a period.

Such traffic information may be indicated and/or transmitted to the network by using one or any combination of the following message/sequence: one or more UCIs/UCI-formats; one or more MAC-CEs/MAC-CE formats; or one or more RRC message(s).

In examples, the WTRU may be configured and/or scheduled with a multi-bit SR, which may be transmitted in a UCI/UCI-format. The WTRU may use multi-bit SR to indicate the amount and/or availability of delay-critical in its buffer. In examples, the WTRU may be configured with one or more BSR formats, which may be used for transmission in low-latency and/or non-low-latency resources. The WTRU may be configured with one or more BSR formats (e.g., a low-latency-BSR) for transmission in a low-latency resource. In examples, the WTRU may be configured with one or more DSR formats, which may be used for transmission in low-latency and/or non-low-latency resources. The WTRU may be configured with one or more DSR formats (e.g., a low-latency-DSR) for transmission in a low-latency resource only. In examples, the WTRU may transmit UAI to indicate its traffic information for transmission in a low-latency resource.

The WTRU may convey one or more of the messages using one or any combination of the following channel(s) and/or signal(s), which may be transmitted in one or more low-latency and/or non-low-latency resources. The WTRU may convey one or more messages using one or more sequences (e.g., a PRACH). In examples, the WTRU may use PRACH to transmit one sequence (e.g., with associated sequence index).

The WTRU may convey one or more messages using one or more PUCCH transmissions. In examples, the WTRU may use PUCCH to transmit SR, multi bit SR to indicate its traffic information.

The WTRU may convey one or more messages using one or more PUSCH transmissions. In examples, the WTRU may use PUSCH to transmit MAC-CE, and/or RRC to indicate its traffic information.

Methods for triggering low-latency transmission may be provided. A WTRU may trigger construction and/or transmission of a UCI/MAC-CE to report the traffic information. The WTRU may be configured to send a UCI/MAC-CE (e.g., low-latency-SR, low-latency-MAC-CE, low-latency-BSR, low-latency-DSR) to indicate and/or report the traffic information to the network using a low-latency resource. Such UCI/MAC-CE may include a limited traffic information with limited number of information bits, which may be designed to balance between QoS achievement and the spectrum efficiency of the system. The WTRU may trigger construction and/or transmission of a UCI/MAC-CE (e.g., low-latency-SR, low-latency-MAC-CE, low-latency-BSR, low-latency-DSR) to report the traffic information to the network based on one or any combination of the following triggering conditions.

The WTRU may trigger construction and/or transmission of a UCI/MAC-CE based on the arrival and/or availability of one or more control/data units associated with a configured set of QoS/QoS treatment profile (RBs/LCHs/LCGs) for low-latency reporting. In examples, the WTRU may be configured to report traffic information (e.g., low-latency-BSR/low-latency-DSR) associated with a set of RBs/LCHs/LCGs in a low-latency resource. The WTRU may trigger construction and/or transmission of a low-latency-BSR/low-latency-DSR if it has control/data associated with the configured RBs/LCHs/LCGs arriving at its buffer.

The WTRU may trigger construction and/or transmission of a UCI/MAC-CE based on the QoS and/or QoS-treatment profile (e.g., RBs/LCHs/LCGs) associated with the control/data to be reported to the network. In examples, the WTRU may trigger construction and/or transmission of a low-latency-BSR/low-latency-DSR if the (remaining) latency budget of the control/data to be reported to the network is smaller than a configured threshold.

The WTRU may trigger construction and/or transmission of a UCI/MAC-CE based on the QoS and/or QoS-treatment profile associated with the control/data unit in the buffer. In examples, the WTRU may trigger construction and/or transmission of a low-latency-BSR/low-latency-DSR if the (e.g., remaining) latency budget associated with its control/data is smaller than a configured threshold. If the (e.g., remaining) delay budget of the control/data in the buffer is larger than the configured threshold, the WTRU may not generate the low-latency-BSR/low-latency-DSR. The WTRU may not use a low-latency resource for reporting non-delay critical data.

The WTRU may trigger construction and/or transmission of a UCI/MAC-CE based on the availability of one or more (e.g., valid) low-latency resources within a period, in which the period may be fixed, or configured by the network. The configured period may be a function of the (remaining) latency budget of the control/data units in the buffer. In examples, the WTRU may construct and/or transmit a low-latency-BSR/low-latency-DSR if it has a (valid) low-latency resource within a period, if the WTRU has control/data for transmission in its buffer. If there is no low-latency resource within a period, the WTRU may not construct the low-latency-BSR/low-latency-DSR for low-latency transmission. This approach may be motivated to help the WTRU not to generate MAC-CE if it is not timely transmitted.

The buffer status of the WTRU, which may include the amount and/or availability of control/data units in each QoS and/or QoS treatment profile (e.g., each RB/LCH/LCG), the amount/availability of control/data units configured for low-latency transmission, the amount/availability of control data units not configured for low-latency transmission, and/or the total amount of control/data units in the buffer. In examples, the WTRU may trigger construction/transmission of a low-latency-BSR/low-latency-DSR if the amount of control/data in its buffer is smaller/larger than a configured threshold. If the amount of control/data in its buffer is larger or smaller than the configured threshold, the WTRU may not trigger low-latency-BSR/low-latency-DSR. If the amount of control/data in its buffer is larger or smaller than the configured threshold, the WTRU may trigger non-low-latency BSR/DSR (e.g., normal BSR/DSR).

The WTRU may trigger low-latency transmission. The WTRU may be configured and/or scheduled with a set of low-latency resources. The WTRU may have one or more control/data units (e.g., a UCI, MAC-CE, a SDU, and/or a TB) for multiplexing and/or transmission. The WTRU may determine (e.g., determine whether) to trigger transmission of the control/data units using low-latency and/or non-low-latency resource. Such determination may be based on one or any combination of the following.

The WTRU may determine to trigger transmission of the control/data units using low-latency and/or non-low-latency resource based on the property associated with the control/data. In examples, the WTRU may be configured with a set of control/data units (e.g., a UCI MAC-CE for HARQ feedback, SR, and/or CSI reporting, a MAC-CE for HARQ feedback, SR, and/or CSI reporting, a low-latency-SR, a low-latency-RRC/MAC-CE/UCI, a low-latency-BSR, a low-latency-DSR, low-latency-TB, delay-critical TB) to be transmitted in a low-latency resource. The WTRU may trigger low-latency transmission of the control/data unit if such control/data unit is available for transmission.

The WTRU may determine to trigger transmission of the control/data units using low-latency and/or non-low-latency resource based on an indication and/or configuration from the network. In examples, the WTRU may be scheduled with a non-low-latency resource (e.g., a configured grant). The WTRU may receive an indication from the network to prioritize (e.g., always prioritize) the grant (e.g., the non-low-latency grant) over another low-latency grant. The WTRU may prioritize transmission in a non-low-latency resource over a low-latency resource.

The WTRU may determine to trigger transmission of the control/data units using low-latency and/or non-low-latency resource based on the QoS and/or QoS-treatment profile (e.g., RB/LCH) associated with the control/data units in the buffer. In examples, the WTRU may be configured with a set control units (e.g., one or more MAC-CEs, one or more UCIs) to be transmitted in a low-latency resource. In examples, the WTRU may be configured to transmit a low-latency-BSR, which may be used to indicate the buffer status of one highest priority LCH/LCG, in a low-latency resource. The WTRU may transmit the low-latency-BSR in the configured/scheduled low-latency resource if the low-latency-BSR is available. In examples, the WTRU may be configured with a set of RBs/LCHs to be transmitted in a low-latency resource. The WTRU may trigger transmission of a control/data units in a low-latency resource if the control/data unit belongs to the set of RBs/LCHs configured for low-latency transmission. In examples, the WTRU may determine whether to trigger transmission of a control/data units in a low-latency resource based on QoS associated with the control/data unit. In examples, the WTRU may trigger transmission of a control/data unit in a low-latency resource if the priority associated with the control/data unit is greater than a configured threshold. In examples, the WTRU may trigger transmission of a control/data unit in a low-latency resource if the (remaining) delay budget associated with the control/data unit is smaller than a configured threshold.

The WTRU may determine to trigger transmission of the control/data units using low-latency and/or non-low-latency resource based on the QoS/QoS-treatment profile associated with the control/data (e.g., RB/LCH) to be reported in a traffic information reporting and/or the QoS/QoS-treatment profile associated with the control/data units triggering the traffic information reporting. The WTRU may be configured/scheduled with a set of low-latency resources to report the traffic information of the WTRU (e.g., low-latency SR/DSR/BSR transmission). The WTRU may use one or more of UCIs (e.g., SR), MAC-CEs (e.g., BSR/DSR), and/or a RRCs (e.g., UAI) messages to report the traffic information. If the traffic information reporting is triggered, the WTRU may determine whether to transmit the traffic information reporting using low-latency transmission (e.g., UCI, MAC-CE, RRC) based on the QoS/QoS-treatment profile associated with the control/data units (e.g., RB/LCH) to be reported and/or the QoS/QoS-treatment profile associated with the control/data triggering the report.

In examples, the WTRU may use a low-latency resource to transmit the MAC-CE if the MAC-CE (e.g., DSR/BSR) is triggered by the availability and/or arrival of the control/data in a configured set of RBs/LCHs, which may be configured for low-latency MAC-CE reporting. In examples, the WTRU may use a low-latency resource for transmission of the MAC-CE (e.g., DSR/BSR) if the QoS associated with the reported control/data satisfies a configured threshold. In examples, the WTRU may use a low-latency resource if the priority/importance associated with the reported control/data is larger than a configured threshold. In examples, the WTRU may use a low-latency resource if the (remaining) latency budget associated with the reported control/data is smaller than a configured threshold. In example, the WTRU may use a low-latency resource for transmission of a UCI (e.g., multi-bit SR) if the UCI is triggered by the availability/arrival of a configured set of RBs/LCHs. The WTRU may use a low-latency resource for transmission of the UCI (e.g., multi-bit SR) if the QoS associated with the control/data satisfies a configured threshold. The WTRU may use a low-latency resource for transmission of the UCI (e.g., multi-bit SR) if the priority/importance associated with the control/data triggering the UCI is larger than a configured threshold. In examples, the WTRU may use a low-latency resource for transmission of the UCI (e.g., multi-bit SR) if the (remaining) latency associated with the control/data triggering the UCI is smaller than a configured threshold.

The WTRU may determine to trigger transmission of the control/data units using low-latency and/or non-low-latency resource based on the buffer status of the WTRU, which may include the amount and/or availability of control/data units in each QoS/QoS treatment profile (e.g., each RB/LCH/LCG), the amount/availability of control/data units configured for low-latency transmission, the amount/availability of control data units not configured for low-latency transmission, and/or the total amount of control/data units in the buffer. In example, the WTRU may trigger low-latency transmission based on the amount of control/data units configured for low-latency transmission. The WTRU may trigger low-latency transmission if the amount of control/data units configured for low-latency transmission is smaller/larger than a configured threshold. If the amount of control/data units configured for low-latency transmission is larger/smaller than the configured threshold, the WTRU may trigger non-low-latency transmission. In examples, the WTRU may determine whether to trigger low-latency transmission for the control/data units in the buffer based on the availability of control/data units not configured for low-latency transmission. The WTRU may not trigger low-latency transmission if the WTRU has control/data units not configured for low-latency transmission. The WTRU may trigger non-low-latency transmission for the control/data units in the buffer. The WTRU may trigger sending non-low-latency UCI/MAC-CE to the network in this case. If the WTRU (only) has control/data units configured for low-latency transmission, the WTRU may trigger low-latency transmission. In examples, the WTRU may determine whether to trigger low-latency transmission for the control/data units in the buffer based on the amount of control/data in the buffer. The WTRU may trigger low-latency transmission if the amount of control/data unit in the buffer is smaller/larger than a configured threshold. If the amount of control/data in the buffer is larger/smaller than a configured threshold, the WTRU may not trigger low-latency transmission. The WTRU may trigger non-low-latency transmission for this case.

The WTRU may determine to trigger transmission of the control/data units using low-latency and/or non-low-latency resource based on the availability of one or more (e.g., valid) low-latency resources within a period, in which the period may be fixed, or configured by the network. The configured period may be a function of the (remaining) latency budget of the control/data units in the buffer. In examples, the WTRU may trigger transmission of the control/data unit in one or more low-latency resources if the WTRU has a (e.g., a valid) low-latency resource available within a period. The WTRU may trigger non-low-latency transmission for the control/data unit. In examples, the WTRU may trigger sending UCI (e.g., SR), which may be non-low-latency (e.g., dedicated to the WTRU) if the WTRU does not have a (valid) low-latency resource available within a period.

The WTRU may determine to trigger transmission of the control/data units using low-latency and/or non-low-latency resource based on the availability of one or more (e.g., a valid) non-low-latency resources within a period, in which the period may be fixed, or configured by the network. The configured period may be a function of the (e.g., remaining) latency budget of the control/data units in the buffer. In examples, the WTRU may trigger transmission of the control/data unit in one or more low-latency resources if the WTRU does not have one or more (e.g., a valid) non-low-latency resources available within a period. If the WTRU has non-low-latency resource available within a period, the WTRU may not trigger low-latency transmission for the control/data units. The WTRU may trigger transmission of the control/data unit using one or more non-low-latency resources.

The WTRU may determine to trigger transmission of the control/data units using low-latency and/or non-low-latency resource based on the availability of one or more (e.g., a valid) non-low-latency resources before one or more low-latency resources. In examples, the WTRU may trigger transmission of the control/data unit in one or more low-latency resources if the WTRU does not have one or more (e.g., a valid) non-low-latency resources before one or more low-latency resources. If the WTRU has one or more non-low-latency resources before one or more low-latency resources, the WTRU may trigger transmission of the control/data unit using one or more non-low-latency resources.

The WTRU may determine to trigger transmission of the control/data units using low-latency and/or non-low-latency resource based on the relative timing associated with the two types of resources (e.g., the relative timing of the low-latency and non-low-latency resource). In examples, the WTRU may prioritize using the earlier resource. If the low-latency resource is available first, the WTRU may use the low-latency resource. The WTRU may determine to continue using the non-low-latency resource for a new control/data transmission and/or for retransmission of the control/data units, which may be transmitted previously in a low-latency resource. In examples, if the non-low-latency resource is available first, the WTRU may perform transmission in the non-low-latency resource. The WTRU may skip transmission in a low-latency resource for a period. This approach may be motivated to reduce the collision in the low-latency resource as the WTRU has transmitted to the network in a non-low-latency resource.

The WTRU may determine to trigger transmission of the control/data units using low-latency and/or non-low-latency resource based on The (pre-)configured precedence/priority associated with the low-latency and non-low-latency resource. In examples, the WTRU may be configured to prioritize non-low-latency resource. The WTRU may use the non-low-latency resource to transmit the control/data if the non-low-latency resource is available within a period. If there is no non-low-latency resource available within a period, the WTRU may use a low-latency resource. The period to determine the availability of a non-low-latency resource may be fixed, or configured by the network, which may be a function of the (remaining) latency budget of the control/data units in the buffer.

The WTRU may determine to trigger transmission of the control/data units using low-latency and/or non-low-latency resource based on the property of the resources, in which the property of a resource may include any parameter configured for the resource such as the size, the priority, the number of (re)transmission resources, the configured transmission parameters (e.g., the transmission beam, the beam pattern), the channel (e.g., PUCCH, PUSCH), the associated reference signals (e.g., CSI-RS ID, SSB-ID), the bandwidth of the resource, the timing of the resource. In examples, the WTRU may trigger transmission of the control/data unit using a non-low-latency resource if the size of the resource is greater than a threshold. If the size of the non-low-latency resource is smaller than a threshold, the WTRU may prioritize triggering the transmission of the control/data units using a low-latency resource.

The WTRU may determine to trigger transmission of the control/data units using low-latency and/or non-low-latency resource based on the relative parameters in the property of the two resources (e.g., the relative size, the relative number of repetitions between two resources). In examples, the WTRU may prioritize triggering transmission of the control/data unit in a resource with larger size. In examples, the WTRU may prioritize triggering transmission of the control/data units using PUCCH channel.

A WTRU may determine whether a resource is valid. The WTRU may be configured and/or scheduled with an uplink resource (e.g., a low-latency resource, a non-low-latency resource). The WTRU may transmit in the scheduled and/or configured resource if the resource is valid. The WTRU may not transmit in the resource (e.g., the resource is invalid). The WTRU may determine whether the resource is valid or invalid based on one or any combination of the following.

The WTRU may determine whether the resource is valid or invalid based on the channel measurement (e.g., RSSI, RSRP measured in an associated reference signal such as CSI-RS, SSB) associated with the resource. In examples, the WTRU may be configured and/or scheduled with one or more low-latency resources, in which each low-latency resource may have an associated set of downlink transmission for measurement (e.g., SSB, CSI-RS). The WTRU may determine whether the resource is valid based on the measurement of the associated reference signals. If the channel measurement (e.g., RSSI, RSRP) of the associated reference signal(s) (e.g., SSB, CSI-RS) is smaller/larger than a configured threshold, the WTRU may consider the resource as valid; if the channel measurement of the associated reference signals(s) is larger/smaller than the configured threshold, the WTRU may consider the resource as invalid.

The WTRU may determine whether the resource is valid or invalid based on the property of the resources, in which the property of a resource may include any parameter configured for the resource such as the size, the priority, the number of (re)transmission resources, the configured transmission parameters (e.g., the transmission beam, the beam pattern), the channel (e.g., PUCCH, PUSCH), the associated reference signals (e.g., CSI-RS ID, SSB-ID), the bandwidth of the resource, the timing of the resource. In examples, the WTRU may determine the resource as valid if the size of the resource is greater than a threshold. The WTRU may consider the resource as invalid. The threshold may be fixed, configured by the network, and/or determined based on other criteria such as the buffer status of the WTRU.

The WTRU may determine whether the resource is valid or invalid based on the priority associated with the resource. In examples, the WTRU may be configured/indicated with a priority per resource. The WTRU may consider the resource as valid if the priority associated with the resource is larger/smaller than a configured threshold. If the priority associated with the resource is smaller and/or larger than the configured threshold, the WTRU may consider the resource as invalid.

The WTRU may determine whether the resource is valid or invalid based on the latency associated with the resource. In examples, the WTRU may determine the resource as valid if the time gap to the resource (e.g., the duration from the availability of the control/data units to the slot of the resource) is smaller than a threshold, in which the threshold may be fixed, configured, and/or determined based on the (remaining) latency budget of the control/data unit.

The WTRU may determine whether the resource is valid or invalid based on the collision with another transmission/reception. In examples, the WTRU may determine the resource as invalid if it collides with a higher priority transmission/reception. The priority of the low-latency transmission and/or the other transmission/reception may be configured/indicated by the network.

The WTRU may determine whether to use a low-latency resource. The WTRU may be configured and/or scheduled with an uplink resource (e.g., a low-latency resource). The WTRU may determine whether to use a low-latency resource for uplink transmission based on one or any combination of the following.

The WTRU may determine whether to use a low-latency resource for uplink transmission based on the validity of the low-latency resource. In examples, the WTRU may determine to skip the resource if it is invalid. The WTRU may use the resource if it is valid.

The WTRU may determine whether to use a low-latency resource for uplink transmission based on the buffer status of the WTRU, which may include the amount and/or availability of control/data units in each QoS/QoS treatment profile, the amount/availability of control/data units configured for low-latency transmission, the amount/availability of control data units not configured for low-latency transmission, and/or the total amount of control/data units in the buffer. In examples, the WTRU may be configured to transmit low-latency-BSR in a low-latency resource. The WTRU may use the low-latency resource if the low-latency-BSR is available/triggered. In examples, the WTRU may use a low-latency resource if the amount of control/data in the buffer is smaller/larger than a configured threshold. If the amount of control/data in the buffer is larger/smaller than the configured threshold, the WTRU may not use the low-latency resource.

The WTRU may determine whether to use a low-latency resource for uplink transmission based on the QoS/QoS-treatment profile associated with the control/data unit in the buffer. In examples, the WTRU may be configured with a set of LCHs to be transmitted in a low-latency resource. The WTRU may use the low-latency resource if it has data in the configured LCHs. In examples, the WTRU may be configured to transmit delay-critical control/data in a low-latency resource. The WTRU may use the low-latency resource if it has delay-critical control/data in its buffer.

The WTRU may determine whether to use a low-latency resource for uplink transmission based on the availability of other type of resource (e.g., non-low-latency resource). In example, the WTRU may use the low-latency resource if it does not have one or more non-low-latency resource within a period, in which the period may be fixed or configured by the network. The configured period may be a function of the QoS/QoS treatment (e.g., the (remaining) latency budget) of the control/data units in the buffer. If the WTRU does not have one or more low-latency resources within a period, the WTRU may use the low-latency resource.

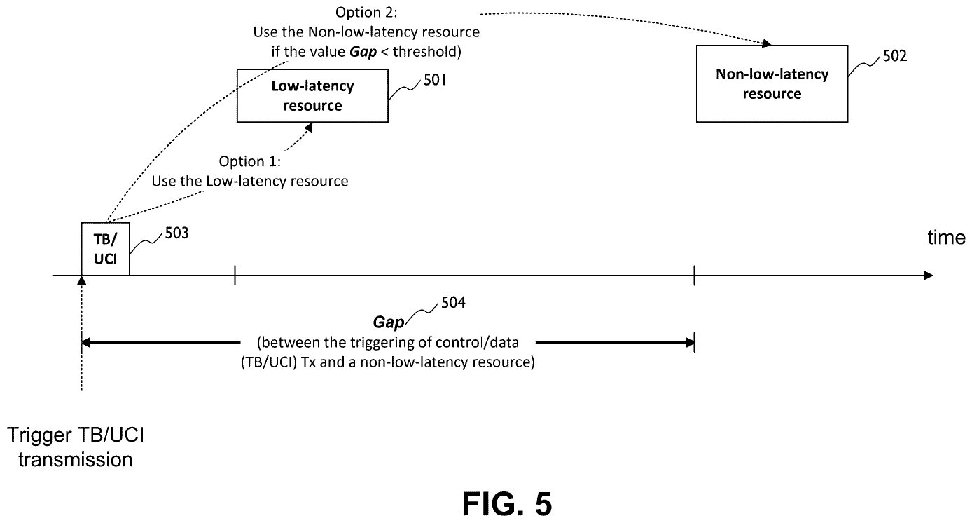

FIG. 5 illustrates a WTRU determining whether to use a low-latency resource 501 based on the availability of a non-low-latency resource 502 within a period. In an example shown in FIG. 5, the WTRU may have a control/data unit 503 for transmission. The WTRU may determine whether to use a low-latency resource 501 based on the availability of a non-low-latency resource 502 within a period. The WTRU may be scheduled and/or configured with a non-low-latency resource (e.g., a configured grant), in which the duration between the triggering of the control/data unit transmission and the resource is denoted as Gap 504. The WTRU may use the non-low-latency resource 502 if the value of Gap 504 is smaller than a threshold. If the value of Gap 504 is larger than a configured threshold, the WTRU may use the low-latency resource 501.

The WTRU may cancel a UCI/MAC-CE. The WTRU may be configured to send a UCI/MAC-CE (e.g., low-latency-SR, low-latency-MAC-CE, low-latency-BSR, low-latency-DSR, non-low-latency BSR/DSR) to indicate and/or report the traffic information to the network using a low-latency resource. The WTRU may trigger construction and/or transmission of a UCI/MAC-CE. The WTRU may determine to cancel the UCI/MAC-CE based on one or any combination of the following.

The WTRU may determine to cancel the UCI/MAC-CE based on if the WTRU has transmitted the constructed UCI/MAC-CE for a configured number of times. In examples, the WTRU may cancel a low-latency-BSR/low-latency-DSR if it has transmitted the low-latency-BSR/low-latency-DSR for a configured number of times.

The WTRU may determine to cancel the UCI/MAC-CE based on if the WTRU has received the implicit and/or explicit indication from the network of successfully receiving the UCI/MAC-CE transmitted in the low-latency resource. In examples, the WTRU may receive an uplink scheduling after transmission of a low-latency-BSR/low-latency-DSR, the WTRU may assume that the low-latency-BSR/low-latency-DSR is received successfully. The WTRU may cancel the low-latency-BSR/low-latency-DSR. In examples, the WTRU may receive an indication (e.g., in an RRC, MAC-CE, and/or DCI) implicitly or explicitly indicating that the UCI/MAC-CE transmitted in a low-latency resource is successfully received.

The WTRU may determine to cancel the UCI/MAC-CE based on if the WTRU has (e.g., successfully) transmitted all the control/data reported/to-be-reported in the UCI/MAC-CE. In examples, the WTRU may first trigger transmission of low-latency-BSR/low-latency-DSR. The WTRU may perform uplink transmission (e.g., in a configured grant), which may include all of the control/data reported/to-be-reported in the triggered low-latency-BSR/low-latency-DSR. The WTRU may cancel the trigger low-latency-BSR/low-latency-DSR.

The WTRU may determine to cancel the UCI/MAC-CE based on if the WTRU has (e.g., successfully) transmitted another associated UCI/MAC-CE. In examples, the WTRU may first trigger transmission of low-latency-BSR/low-latency-DSR. The WTRU may perform uplink transmission (e.g., in a configured grant), in which the WTRU may include a normal BSR/DSR, which may contain the information of the low-latency-BSR/low-latency-DSR. The WTRU may cancel the low-latency-BSR/low-latency-DSR. In examples, the WTRU may be configured with multiple BSR/DSR formats, which may be transmitted in a low-latency or non-low-latency resource. The WTRU may first trigger transmission of a low-latency-BSR/low-latency-DSR. The WTRU may transmit another BSR/DSR format, which may include the traffic information conveyed in the triggered low-latency-BSR/low-latency-DSR. The WTRU may cancel the triggered low-latency-BSR/low-latency-DSR. In examples, the WTRU may trigger transmission of a non-low-latency BSR/DSR (e.g., a legacy BSR/DSR). The WTRU may determine to cancel the non-low-latency BSR/DSR if the WTRU successfully transmit the low-latency-BSR/DSR. In examples, if a low-latency-BSR/DSR is transmitted, the WTRU may receive an uplink grant from the network. The WTRU may cancel the triggered non-low-latency BSR/DSR. The WTRU may cancel the non-low-latency BSR/DSR as the network may be aware of the traffic information from the successfully transmitted low-latency-BSR/DSR.

The WTRU may determine to cancel the UCI/MAC-CE based on the time elapsed from triggering of UCI/MAC-CE is greater than a configured threshold. In examples, the WTRU may cancel the triggered UCI/MAC-CE after the UCI/MAC-CE is triggered for a period, in which the period may be fixed/configured by the network. The configured period may be a function of the (remaining) latency budget of the control/data units in the buffer. For implementation, the WTRU may start a timer after triggering the UCI/MAC-CE, in which the initial timer may be fixed/configured. The initial value of the timer may be configured as a function of the (remaining) latency budget of the control/data units in the buffer. The WTRU may cancel the triggered UCI/MAC-CE if the timer expired.

The WTRU may determine to cancel the UCI/MAC-CE based on if one, multiple, and/or all control/data units to be reported in the UCI/MAC-CE may be discarded and/or obsoleted. In examples, the WTRU may be configured with a discardTimer for each control/data unit. The WTRU may start the discardTimer if the control/data units arrive at the buffer. The WTRU may discard the control/data units if the timer expires. The WTRU may cancel the triggered UCI/MAC-CE if all the control/data units to be reported in the UCI/MAC-CE is discarded.

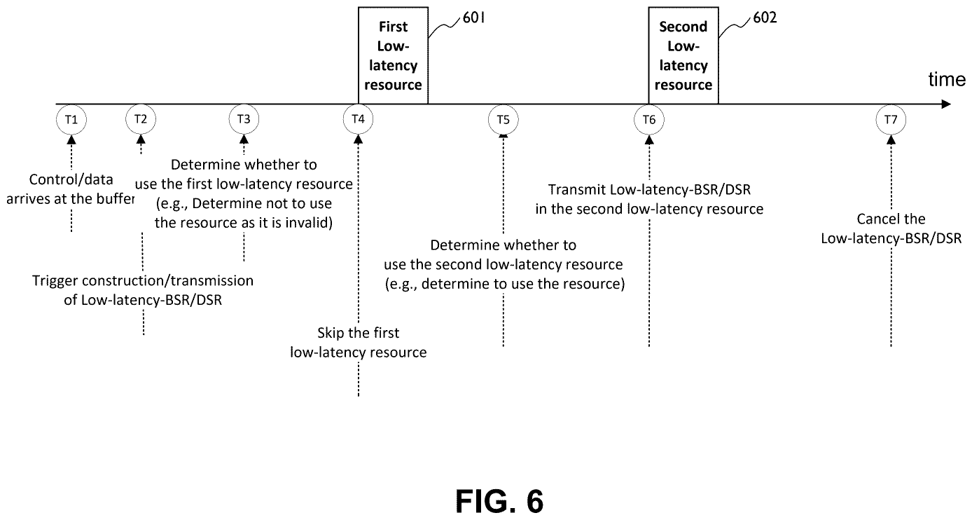

FIG. 6 illustrates an example of low-latency-BSR/low-latency-DSR transmission in a low-latency resource. FIG. 6 describes an example procedure for Low-latency-BSR/Low-latency-DSR transmission in a low-latency resource. At time T1, the WTRU may have control/data available at the buffer. The WTRU may trigger construction of Low-latency-BSR/Low-latency-DSR to report the traffic information to the network using a low-latency resource at time T2. At time T3, the WTRU may determine whether to transmit the constructed low-latency-BSR/low-latency-DSR in the first low-latency-resource 601. The WTRU may determine that the resource is invalid (e.g., due to the measured RSRP in the associated reference signal is smaller than a configured threshold). At time T4, the WTRU may skip the first low-latency-resource. At time T5, the WTRU may determine to use the second low-latency-resource 602 and/or perform transmission of the constructed low-latency-BSR/low-latency-DSR at time T6. The WTRU may cancel the low-latency-BSR/low-latency-DRS at time T7 (e.g., as the low-latency-BSR/low-latency-DRS is successfully transmitted to the network).

Methods for multiplexing control/data for uplink transmission may be provided. A WTRU may determine which control/data unit and the number of bits to multiplex in a bit-sequence. The WTRU may be configured and/or scheduled with an uplink grant, which may be a low-latency grant. The WTRU may determine to perform transmission in the uplink grant. The WTRU may determine which control/data unit(s) and the number of the control/data bits to multiplex in the grant (e.g., in LCP procedure). The WTRU may determine whether each control/data unit may be multiplexed in the grant. Such decisions (e.g., which control/data unit(s) and/or whether a control/data unit may be transmitted in a grant) may be determined based on one or any combination of the following.

Which control/data unit(s) and/or whether a control/data unit may be transmitted in a grant may be determined based on an indication/configuration from the network. In examples, the WTRU may be configured with a MAC-CE format (e.g., a low-latency-BSR) to be transmitted in a low-latency uplink grant. The WTRU may include the configured MAC-CE format to transmit in the configured/scheduled low-latency uplink grant. In examples, in a low-latency resource, the WTRU may be configured to transmit BSR/DSR only, BSR/DSR and data, BSR and other MAC-CE only, and/or BSR and other MAC-CEs and data. The WTRU may multiplex the configured control/data units in a low-latency resource based on the configuration/indication from the network. In examples, the WTRU may be configured to transmit an UCI (e.g., multi-bit SR) in a low-latency uplink grant. The WTRU may transmit the configured UCI in the configured low-latency uplink resource.

Which control/data unit(s) and/or whether a control/data unit may be transmitted in a grant may be determined based on the QoS/QoS treatment profile associated with the control/data units reported in the transmission. In examples, the WTRU may have a valid low-latency resource. The WTRU may have BSR triggered. The WTRU may determine whether to include the triggered BSR in the transmission in the low-latency resource based on the content of the BSR. If the BSR includes the traffic information of the RB(s)/LCH(s) in a set of configured RBs/LCHs, the WTRU may multiplex the triggered BSR in the transmission. The WTRU may not multiplex the BSR in the transmission.

In examples, the WTRU may have DSR triggered. The WTRU may have a low-latency resource for transmission. The WTRU may determine to multiplex the DSR in the transmission if the (e.g., remaining) latency budget of the control/data reported in the DSR is smaller/larger than a configured threshold. If the (e.g., remaining) latency budget of the control/data reported in the DSR is larger/smaller than the configured threshold, the WTRU may not multiplex the triggered DSR in the transmission.

Which control/data unit(s) and/or whether a control/data unit may be transmitted in a grant may be determined based on a QoS/QoS treatment profile associated with the control/data unit. In examples, the WTRU may perform the LCP procedure to multiplex the control/data in a TB for transmission in the low-latency resource. The WTRU may prioritize the control/data units to multiplex in the TB based on the QoS/QoS treatment profile (e.g., priority, (remaining) latency) associated with the control/data units and the configured prioritized bit rate value associated with the LCH of the control/data units.

In examples, the WTRU may be configured with a set of QoS/QoS treatment profile (e.g., RBs/LCHs/LCGs) to be multiplexed in a TB for transmission in a low-latency resource. The WTRU may prioritize to multiplex the control/data units belong to the configured QoS/QoS treatment profile. In examples, the WTRU may determine whether to multiplex a control/data unit in the TB for transmission in the low-latency resource based on the QoS/QoS treatment profile associated with the control/data unit. In examples, the WTRU may multiplex the control/data unit in the TB if the (e.g., remaining) latency associated with the control/data units is smaller/larger than a configured threshold. In examples, the WTRU may multiplex the control/data unit in the TB if the priority associated with the control/data unit is larger or smaller than a configured threshold.

A WTRU may prioritize the control/data units configured with low-latency transmission. The WTRU may be configured with a set of QoS/QoS treatment profile (e.g., RBs/LCHs/LCGs) associated with a set of low-latency transmission resources. The WTRU may perform a multiplexing procedure to multiplex the control/data units in a bit-sequence for transmission in a low-latency resource. The WTRU may prioritize the control/data units belonging to the set of QoS/QoS treatment profile associated with the low-latency transmission. The WTRU may multiplex the control/data belonging to the QoS/QoS treatment profiles associated with the low-latency transmission resource. The WTRU may zero the remaining resource to fulfill the size of the grant. The WTRU may multiplex control/data units regardless of whether the control/data unit belongs to the QoS/QoS treatment profile associated with the low-latency transmission resource. The WTRU may multiplex the control/data unit belonging to the QoS/QoS treatment profile associated with the low-latency resource. The WTRU may multiplex the control/data unit from other QoS/QoS treatment profile(s) if it has remaining resources in the grant.

Feature(s) associated with determination of Tx parameters may be provided. A WTRU may be configured with multiple sets of low-latency resources. The WTRU may be configured and/or scheduled with one or more set of low-latency resources. The WTRU may be configured and/or scheduled with one or more of the following parameters for each set of low-latency resources.

The WTRU may be configured and/or scheduled with the transmission beam(s) and/or beam pattern associated with one or more transmissions in the low-latency resources.

The WTRU may be configured and/or scheduled with the frequency resource for each transmission (e.g., the first and/or second resource). In examples, the WTRU may be configured with multiple set of low-latency resources in which each set of resources may be associated with a range of RBs, a BWP, a CCs.

The WTRU may be configured and/or scheduled with the time resource for each transmission, which may include the timing and the duration of each transmission. In examples, for one set of low-latency resources, the WTRU may be configured whether to transmit over one or multiple slots. In one configuration, the WTRU may be configured with transmission within one slot. The WTRU may be configured with repetitions in this configuration. In another configuration, the WTRU may be configured with one transmission over multiple slots such as TBoMS (TB over multiple slots).

The WTRU may be configured and/or scheduled with the number of repetitions for transmission of the bit-sequence (e.g., UCI/MAC-CE/TB). The WTRU may be configured and/or scheduled with one or more parameters to determine the transmission power such as the expected reception power at the gNB, scaling factor. The WTRU may be configured and/or scheduled with the MCS. The WTRU may be configured and/or scheduled with one or more parameters associated with the frequency hopping such as frequency hopping enabled/disabled.

The WTRU may be configured and/or scheduled with the HARQ RV (patterns) associated with the transmission. The WTRU may be configured and/or scheduled with the associated reference signal (e.g., CSI-RS, SSB). The WTRU may be configured and/or scheduled with the periodicity associated with the set of resources.

The WTRU may determine the transmission parameters for an uplink transmission. The WTRU may have a bit-sequence (e.g., a UCI/MAC-CE/TB) to be transmitted in an uplink resource (e.g., low-latency resource). The WTRU may (e.g., then) determine one or any combination of the following transmission parameters: the transmission beam (e.g., SRI, the beam corresponds to an associated reference-signal); the (relative) transmission power; the MCS; the number of repetitions for transmission of the bit-sequence (e.g., UCI/MAC-CE/TB); the HARQ RV associated with the transmission; or the beam pattern used for transmission.

A transmission parameter (e.g., each transmission parameter) may be determined/selected from a set of possible values and/or possible range, which may be configured by the network. One or more transmission parameters may be determined based on one or any combination of the following.

One or more transmission parameters may be determined based on the implicit or explicit indication/configuration from the network. In examples, the WTRU may be configured and/or scheduled with a beam pattern for multiple transmissions of a bit-sequence in a low-latency resource. The WTRU may follow the configured and/or scheduled beam pattern to determine the transmit beam for each transmission of the bit-sequence. In examples, the WTRU may be configured and/or scheduled to use the first SRI for the first transmission and the WTRU may be configured and/or scheduled to use the second SRI for a retransmission of the bit-sequence.

One or more transmission parameters may be determined based on the resource used for transmission of the bit-sequence. In examples, the WTRU may be configured and/or scheduled with a set of transmission parameters to use for each low-latency resource. The WTRU may determine the value of each transmission parameter to use based on the selected resource for low-latency transmission.

One or more transmission parameters may be determined based on the number of (re)transmission attempts (i.e., the (re)transmission index associated with the bit-sequence) for the bit-sequence (e.g., UCI/MAC-CE/TB). In examples, the WTRU may be configured and/or scheduled with one set of transmission parameters for each (re)transmission attempt of a bit-sequence. The WTRU may determine the value of the transmission parameters based on the index of the (re)transmission attempt for the bit-sequence. In examples, the WTRU may determine which beam to use based on the number of (re)transmission made for a bit-sequence in a low-latency resource. The WTRU may use one beam (e.g., the first SRI) for the first transmission attempt. The WTRU may determine to switch to another beam (e.g., the second SRI) after a configured number of (re)transmission attempts for the bit-sequence. In examples, the WTRU may determine which HARQ RV to use based on the number of (re)transmission made for a bit-sequence in a low-latency resource. The WTRU may use one HARQ RV (E.g., RV0) for the first transmission attempt. The WTRU may determine to switch to another HARQ RV (e.g., RV3) after configured number of (re)transmission attempts for the bit-sequence. The WTRU may be configured with a pattern of HARQ RVs as a function of the (re)transmission attempts. For example, the WTRU may follow a configured RV pattern (e.g., RV0, RV2, RV3, RV1) for the transmission attempts in a set of low-latency resource.

In examples, the WTRU may be configured to boost the transmission power after one or more (re)transmission attempt of the bit-sequence. The WTRU may be configured to increase its transmission power with an offset (e.g., 3 dB) after one or a configured number of (re)transmission attempts until it reaches a configured transmission level.

One or more transmission parameters may be determined based on the QoS/QoS treatment profile associated with the transmitted control/data. In examples, the WTRU may be configured and/or scheduled with a low-latency resource, in which each low-latency resource may have a maximum repK repetitions. The WTRU may determine the number of repetitions for a bit-sequence transmission based on the QoS/QoS treatment profile associated with the control/data units in the bit-sequence. In examples, for high priority bit-sequence, the WTRU may use maximum number of repetitions. For low priority bit-sequence, the WTRU may not perform repetitions of the bit-sequence.

One or more transmission parameters may be determined based on the channel measurement of the WTRU such as the measured Uu RSRP, the estimated pathloss. In examples, the WTRU may be configured with the number of repetitions as a function of the measured Uu RSRP. The WTRU may determine the number of repetitions based on the measured Uu RSRP. The WTRU may use the high number of repetitions for low measured Uu RSRP.

One or more transmission parameters may be determined based on the parameters related to transmission power of the WTRU such as the required transmission power, the PHR, the expected transmission power. In examples, the WTRU may be configured with the number of repetitions as a function of the PH. The WTRU may determine the number of repetitions based on the value of PH.

A WTRU may determine which resource to use for its uplink transmission. The WTRU may have control/data for low-latency transmission. The WTRU may select one or more of the configured/scheduled low-latency resources for its uplink transmission. The WTRU may determine which set of low-latency resources from multiple configured/scheduled sets of low-latency resources for its transmission. The WTRU may determine which low-latency resource from one, multiple, or all configured/scheduled sets of low-latency resources. Such decision may be based one or any combination of the following.

The WTRU may determine which low-latency resource from one, multiple, or all configured/scheduled sets of low-latency resources based on the timing of the resource. In examples, the WTRU may prioritize the first configured/scheduled low-latency resource for its uplink transmission (e.g., of low-latency-BSR/DSR). In examples, the WTRU may randomly select one of the configured/scheduled resources within a window from the time low-latency uplink transmission is triggered.

The WTRU may determine which low-latency resource from one, multiple, or all configured/scheduled sets of low-latency resources based on one or more configured and/or indicated transmission parameters associated with the resource. In examples, the WTRU may prioritize the resource associated with the higher number of repetitions, frequency hopping enabled, and/or TBoMS. In examples, the WTRU may prioritize the set of low-latency resources having repetition in different frequency.

The WTRU may determine which low-latency resource from one, multiple, or all configured/scheduled sets of low-latency resources based on the channel measurement of the WTRU such as the measured Uu RSRP, the estimated pathloss. In examples, the WTRU may prioritize selecting the set of low-latency resources associated with TBoMS if the estimated pathloss is smaller than a configured threshold or the measured Uu RSRP is smaller than a configured threshold. In examples, the WTRU may prioritize selecting the set of low-latency resources having the number of repetitions being greater than a configured threshold if the measured Uu RSRP is smaller than a configured threshold.

The WTRU may determine which low-latency resource from one, multiple, or all configured/scheduled sets of low-latency resources based on the parameters related to transmission power of the WTRU such as the required transmission power, the PHR, the expected transmission power. In examples, the WTRU may prioritize the resource set associated with TBoMS if the PH of the WTRU is smaller than a configured threshold. In examples, the WTRU may prioritize the resource set associated with higher number of repetitions if the required transmission power of the WTRU is larger/smaller than a configured threshold.

The WTRU may determine which low-latency resource from one, multiple, or all configured/scheduled sets of low-latency resources based on the QoS/QoS treatment profile associated with the control/data. In examples, the WTRU may be configured a set of QoS/QoS treatment profiles to be transmitted in a set of low-latency resources. The WTRU may select which low-latency resource set for its transmission associated with the control/data based on the QoS/QoS treatment profile of the control/data.

The WTRU may determine which low-latency resource from one, multiple, or all configured/scheduled sets of low-latency resources based on the payload associated with the transmission. In examples, the WTRU may be configured with a range of payloads for transmission in each set of resources. The range of payloads may include one value. The WTRU may determine which set of low-latency resources for its transmission based on the payload associated with the transmission.

Procedures for low-latency transmission may be provided. The WTRU may indicate its WTRU identity (e.g., WTRU ID, WTRU-RNTI such as C-RNTI) to the network, which may help the network in identifying the WTRUs transmitting in a low-latency resource. The WTRU identity may be indicated by the network. In examples, the WTRU identity may be indicated by the network in the configuration and/or scheduling of the low-latency resources. The WTRU may then implicitly or explicitly indicate the indicated WTRU identity in a transmission of a low-latency resource and/or in an associated transmission of the low-latency resource. The WTRU may indicate the WTRU identity by using one or more of the following.

The scrambling code may scramble the transmitted bit-sequence. For example, the WTRU may be indicated with a WTRU identity. The WTRU may use the indicated WTRU identity to scramble the bit-sequence and/or the DMRS to be transmitted in the low-latency resource and/or in the associated resource.

The WTRU may indicate the WTRU identity in the bit-sequence transmitted in the low-latency resource. In examples, the WTRU may be configured with a MAC-CE to indicate its identity (e.g., C-RNTI, WTRU ID) in the bit-sequence to be transmitted in the low-latency resource. The WTRU may indicate the configured MAC-CE in each transmission of the low-latency resource.

The WTRU may indicate the WTRU identity in one associated transmission. In examples, the WTRU may be configured/scheduled with a non-low-latency resource associated with a set of low-latency resources. The WTRU may transmit a sequence (e.g., SR) to indicate that it is using one or more associated low-latency resources. Such indication may explicitly indicate the WTRU identity of the used resource.

The WTRU may indicate the WTRU identity in a transmission indicating the used/to-be-used low-latency resource. In examples, the WTRU may be configured and/or scheduled with a non-low-latency resource (e.g., WTRU-dedicated), which may be associated with a set of low-latency resources. The WTRU may transmit a sequence (e.g., preamble) to indicate its transmission in one or more of the associated low-latency resources.

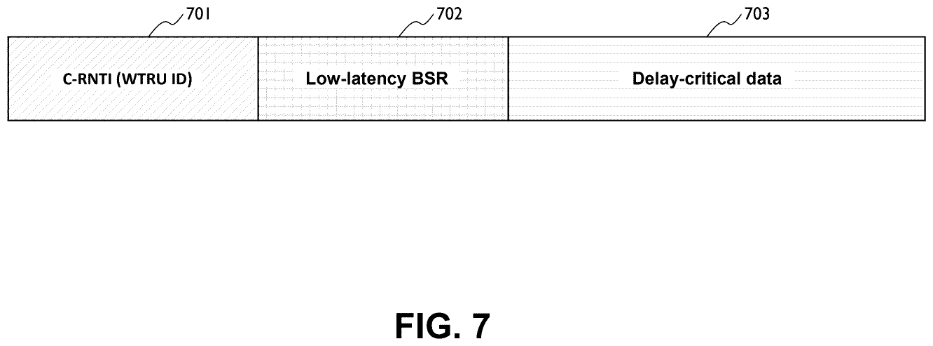

FIG. 7 illustrates a MAC PDU for transmission of low-latency-BSR in a low-latency resource. FIG. 7 illustrates a typical MAC PDU for transmission of low-latency-BSR in a low-latency resource, in which the MAC-PDU includes the C-RNTI 701 (e.g., WTRU ID) of the WTRU, the Low-latency-BSR 702, and the delay-critical data 703.

The WTRU may monitor response from the network after its low-latency transmission. The WTRU may be configured with one or any combination of the following for monitoring the response from the network: one or more CORESETs, one or more search-spaces, or one or more DCI formats.

The WTRU may determine a window to monitor a response from the network after its transmission in a low-latency resource (e.g., low-latency-response window). The low-latency-response window (e.g., duration) may be fixed and/or configured by the network. The low-latency-response window duration may be configured as a function of the QoS/QoS treatment profile associated with the control/data unit in the buffer (e.g., the (remaining) latency budget of the control/data in the buffer).

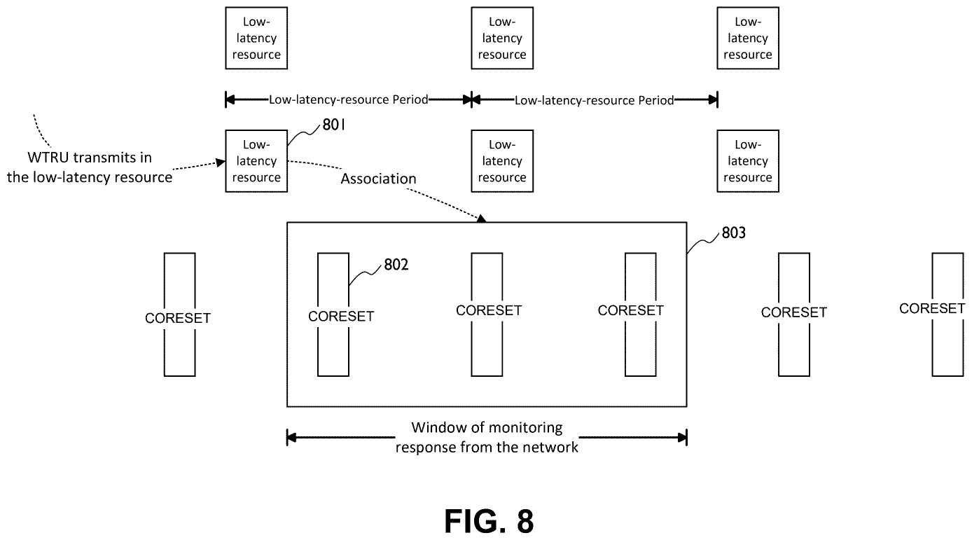

FIG. 8 illustrates monitoring (e.g., by a WTRU) for a response from the network in a window after transmission in a low-latency-resource. In an example shown in FIG. 8, the WTRU may be configured and/or scheduled with a set of periodic low-latency-resources 801 and a CORESET/Search-space 802 to monitor the response from the network after it perform uplink transmission in a low-latency resource 801. The WTRU may perform transmission in one low-latency resource 801. The WTRU may trigger monitoring the response from the network in an associated monitoring window 803. The WTRU may monitor PDCCH in a configured CORSEET within the monitoring to detect potential scheduling decision and/or indication from the network.

The WTRU may determine whether a transmission is successful or not. The WTRU may transmit a bit-sequence (e.g., low-latency-BSR/low-latency-DSR) in a low-latency resource. The WTRU may assume and/or determine the transmission is successful (e.g., successful contention) based on an implicit or explicit indication for acknowledgement (ACK) of the low-latency transmission from the network. The WTRU may assume and/or determine the transmission in the low-latency resource is not successful if it does not receive an implicit or explicit ACK from the network within a configured window after its transmission (e.g., an implicit/explicit indication for a successful contention). The window (e.g., the duration) may be configured from the network, which may be a function of the QoS/QoS treatment profile associated with the reported control/data and/or the QoS/QoS treatment profile (e.g., (remaining) delay budget) of the transmitted control/data units. The WTRU may receive one or any combination of the following implicit or explicit indication from the network to determine whether the low-latency transmission of the bit-sequence is successful.

The WTRU may receive an uplink scheduling. In examples, the WTRU may assume and/or determine that the low-latency-BSR/low-latency-DSR is successfully received by the network if it receives a DCI scheduling an uplink transmission within a configured window after its transmission of the low-latency-BSR/low-latency-DSR. In examples, the WTRU may assume that its low-latency transmission (e.g., BSR/DSR and/or data transmission) is successfully received from the network if it receives a scheduling for a new uplink transmission associated with the same HARQ ID.

The WTRU may receive an indication (e.g., in an RRC, MAC-CE, and/or DCI) implicitly/explicitly indicating that the bit-sequence (e.g., UCI/MAC-CE) transmitted in a low-latency resource is successfully received. In examples, the WTRU may receive a MAC-CE (e.g., in a downlink transmission) implicitly or explicitly indicating that its TB transmission in a low-latency resource is successfully received. The WTRU may receive an indication (e.g., in the MAC-CE) of the successful transmission in which low-latency resource.

An indication (e.g., in an RRC, MAC-CE, and/or DCI) implicitly or explicitly indicating that the bit-sequence (e.g., UCI/MAC-CE) transmitted in a low-latency resource is not successful. In examples, the WTRU may receive an indication from the network to fallback to contention-free transmission (e.g., contention free SR in PUCCH). If such an indication is received from the network, the WTRU may assume that the low-latency transmission may not successfully be received by the network.

The WTRU may receive an indication from the network regarding its transmissions in a low-latency resource. If performing one or more low-latency transmission (e.g., low-latency-BSR/DSR), the WTRU may receive one or more of the following implicit or explicit indication from the network: successful reception of all low-latency transmission; successful reception of the first transmission in the first resource (e.g., PRACH, the WTRU may retransmit the bit-sequence transmitted in the second resource); successful reception of the second transmission; failure in reception in all low-latency transmissions; failure in reception in the first low-latency transmission in the first resource; failure in reception in the second low-latency transmission in the second resource (e.g., the WTRU may provide the C-RNTI in the second transmission. The WTRU may assume that the second transmission is failure if the WTRU detects a DCI with different scrambling code, for example, the DCI scrambling based on the transmission in the first resource); or no indication. If the implicit or explicit indication is received from the network, the WTRU may determine the subsequent procedure based on such indication.

The WTRU may determine that one or more low-latency transmissions of a bit-sequence (e.g., a UCI/MAC-CE/TB) is not successful. Such decision may be based on the WTRU not receiving an implicit or explicit indication of successful contention from the network. The WTRU may (e.g., then) perform one or any combination of the following procedures.

The WTRU may perform retransmission of the bit-sequence in another low-latency resource. The WTRU may retransmit the bit-sequence in a future low-latency resource after the network response monitoring window. The WTRU may retransmit the bit-sequence after an elapsed time from the previous transmission of the bit-sequence. The WTRU may retransmit the bit-sequence after an elapsed time from the end of the network response monitoring window. The elapsed time to reattempt the low-latency transmission of the bit-sequence may be randomly selected from the set of configured value. The elapsed time may be configured and/or selected as a function of QoS/QoS profile associated with its transmission. In examples, the WTRU may be configured and/or scheduled with multiple low-latency resources for transmission of a bit-sequence (e.g., UCI/MAC-CE/TB), in which each low-latency resource may be associated with one set of transmission parameters. The WTRU may not receive response from the network after one or more transmissions of a low-latency-BSR/low-latency-DSR. The WTRU may switch to another low-latency resource for retransmission of the low-latency-BSR/low-latency-DSR. Such new low-latency resource may be associated with different frequency resource, MCS, transmission beam, resource size, and/or payload size compared to the low-latency resource used for the previous transmission. The reliability of the subsequent transmission for the bit-sequence may be improved.

The WTRU may perform transmission of an associated bit-sequence (e.g., an associated UCI/MAC-CE). In examples, the WTRU may be configured with multiple BSR formats to indicate the traffic information, in which a BSR format (e.g., each BSR) format may be associated with a different payload. The WTRU may fail to receive successful contention indication from the network for its transmission of one BSR format in one low-latency resource. The WTRU may trigger transmission of another BSR format (e.g., with smaller payload size) in another low-latency resource. The reliability of the second BSR format may be increased. In examples, the WTRU may first transmit low-latency-BSR/DSR. The WTRU may transmit SR if acknowledgement from the network for the low-latency-BSR/DSR is not received (e.g., failure to receive an acknowledgement from the network). The SR may be transmitted in contention based or non-low-latency resource.

The WTRU may perform another uplink transmission in a non-low-latency resource. In examples, if a successful contention indication is not received (e.g., failure to receive) from the network for its low-latency transmission of low-latency-BSR/low-latency-DSR, the WTRU may trigger transmission of SR to the network, which may be transmitted in a non-low-latency resource.

The WTRU may perform random access. In examples, the WTRU may perform random access if a successful contention indication is not received (e.g., failure to receive) from the network after a configured number of low-latency transmissions.

The WTRU may switch to a different RRC state (e.g., RRC idle). In examples, the WTRU may be in one RRC state (e.g., RRC connected). The WTRU may switch to another state (e.g., RRC idle) if a successful contention indication is not received (e.g., failure to receive) from the network after a configured number of low-latency transmission.

The WTRU may stop transmission of the bit-sequence in a low-latency resource for a period. In examples, if there is a failure of a configured number of low-latency transmission for a bit-sequence, the WTRU may start a prohibit timer. The WTRU may not use a low-latency resource, which may be associated with one or more configured set of low-latency resources, to transmit the bit-sequence. The WTRU may resume using low-latency resource for transmission of the bit-sequence if the timer expires.

The WTRU may override the restriction of a non-low-latency resource if a low-latency transmission fails. The WTRU may be configured with a set of non-low-latency resource. The WTRU may use the resource to transmit UCI/MAC-CE/TB. The WTRU may be configured with a window (e.g., a prohibit timer) after each transmission of SR. The WTRU may override the configured window (e.g., stop the prohibit timer) to further transmit UCI/MAC-CE/TB based on one or any combination of the following.

The WTRU may override the configured window based on if the WTRU fails for contention in one or a configured number of low-latency transmissions. In examples, the WTRU may start a prohibit timer after each transmission of a SR. The WTRU may perform uplink transmission in a low-latency resource. If failure is in contention of one or more low-latency transmission, the WTRU may stop the prohibit timer and transmit the SR in a non-low-latency resource.

The WTRU may override the configured window based on an indication from the network. In examples, if a transmission occurs in a low-latency transmission, the WTRU may receive an implicit or explicit indication from the network to transmit in a non-low-latency resource. The WTRU may trigger transmission in the non-low-latency resource (e.g., SR) without considering whether the prohibit timer is running or not. If the prohibit timer to transmit SR is running, the WTRU may stop the timer and transmit SR in one of the configured/scheduled resource.

The WTRU may determine whether to trigger a subsequent MAC-CE (e.g., BSR/DSR/PHR) in a subsequent Tx. If transmission of a UCI/MA-CE/TB (e.g., low-latency-BSR/low-latency-DSR) in a low-latency resource occurs, the WTRU may implicitly or explicitly receive a successful contention indication from the network. The WTRU may receive a scheduling for an uplink transmission. Such uplink scheduling may be received in the same transmission of successful contention indication. The WTRU may determine (e.g., determine whether) to trigger and/or multiplex a subsequent MAC-CE (e.g., a subsequent BSR/DSR/PHR). The WTRU may trigger transmission of a subsequent MAC-CE to indicate further information about its traffic (e.g., buffer status) and/or power headroom information (e.g., subsequent PHR). Such decision of whether to trigger transmission of a MAC-CE may be based on one or more of the following.

The WTRU may trigger transmission of a subsequent MAC-CE based on configuration/indication from the network. In examples, the WTRU may be configured to always include a subsequent MAC-CE (e.g., a subsequent BSR/DSR/PHR) in one of the scheduled resources after the transmission in a low-latency transmission.

The WTRU may trigger transmission of a subsequent MAC-CE based on whether the scheduled resource is sufficient for transmission of its control/data in the buffer. In examples, the WTRU may include a subsequent BSR/DSR in the transmission if it still has remaining data/control units in its buffer after transmissions in the scheduled grants.

The WTRU may trigger transmission of a subsequent MAC-CE based on whether the WTRU still has delay-critical, high importance, and/or high priority data in its buffer. In examples, the WTRU may include a subsequent BSR/DSR in the transmission if it still has remaining delay-critical, high importance, and/or high priority control/data units in its buffer after transmission in the scheduled grants.

The WTRU may determine the information conveyed in the subsequent MAC-CE (e.g., BSR/DSR). The WTRU may determine the information conveyed in the subsequent MAC-CE (e.g., subsequent BSR/DSR) based on one or more of the following. The WTRU may determine the information conveyed in the subsequent MAC-CE based on the information conveyed in the low-latency-BSR/low-latency-DSR. In examples, the WTRU may report the traffic associated with the QoS/QoS treatment profile (e.g., RBs/LCHs/LCGs) not being configured for reporting in the low-latency-BSR/low-latency-DSR. In examples, the WTRU may report the traffic information not included in the previous low-latency-BSR/low-latency-DSR.

The WTRU may determine the information conveyed in the subsequent MAC-CE based on the current buffer status of the WTRU after the current transmission. In examples, the WTRU may report the traffic associated with the current buffer status of the WTRU after transmission in the scheduled grant.

The WTRU may determine to retransmit one or more control/data units transmitted in a low-latency resource. The WTRU may determine to retransmit one or more control/data units (e.g., UCI/MAC-CE/TB) transmitted in a low-latency resource. Such determination may be based on one or any combination of the following.

The WTRU may determine to retransmit one or more control/data units based on configuration from the network. In examples, the WTRU may be configured to retransmit one or more control/data units (e.g., UCI, MAC-CE) in a non-low-latency resource. The WTRU may multiplex the configured control/data unit in the bit-sequence and transmit in the grant if the non-low latency grant is received from the network.

The WTRU may determine to retransmit one or more control/data units based on implicit or explicit indication from the network. In examples, the WTRU may perform low-latency transmission using two resources (e.g., the first resource for preamble transmission and the second resource for control/data transmission). The WTRU may receive implicit or explicit indication (e.g., via DCI) of successful transmission of the first resource only. The WTRU may retransmit the control/data (e.g., UCI/MAC-CE/TB) in the second resource.

A WTRU may trigger transmission of a set of control/data units allowed and/or indicated to be transmitted in a low-latency resource based on triggering condition(s) for transmission in a low-latency resource being satisfied. A WTRU may perform one or more of the following actions (e.g., may be configured with to perform one or more of the following actions).

The WTRU may receive configuration information (e.g., the WTRU may be configured via the configuration information). The configuration information may include or indicate one or more of the following. The configuration information may include or indicate a set of resources for uplink transmission (e.g., low-latency resources). The configuration information may include or indicate an ID (e.g., C-RNTI, WTRU ID) to transmit in a low-latency resource.

The configuration information may include or indicate a set of control (e.g., UCI, MAC-CE format) and/or data (e.g., DRBs/LCHs) unit(s) to transmit in the low-latency resource, for example. The set of control and/or data units may include a UCI to indicate and/or report the HARQ feedback, SR. The set of control and/or data units may include an MAC-CE to report BSR, DSR, power headroom (PHR), and/or HARQ feedback. The set of control and/or data units may include data associated with a set of LCH(s) and/or DRB(s).

The configuration information may include or indicate one or more conditions to transmit a control unit in a low-latency resource, for example. A condition to transmit a control unit in a low-latency resource may include the WTRU having a BSR to report data in a configured set of LCGs. A condition to transmit a control unit in a low-latency resource may include the WTRU having a DSR to report data with remaining latency being less than a threshold.

The configuration information may include or indicate one or more conditions to transmit a data unit in a low-latency resource, for example. The one or more conditions to transmit a data unit in a low-latency resource may include a priority (e.g., importance parameter) of the data unit being greater a threshold. The one or more conditions to transmit a data unit in a low-latency resource may include a remaining latency budget of the data unit being less than a threshold.

The WTRU may determine that one or more of the configured conditions for using a low-latency resource are met. For example, a configured condition for using a low-latency resource being met may include that a UCI/MAC-CE for reporting HARQ feedback is available and/or that CSI is available. A configured condition for using a low-latency resource may include that a BSR for reporting associated with a set configured LCHs/LCGs (e.g., high priority data) is available. A configured condition for using a low-latency resource may include that a DSR for reporting data has a remaining latency that is smaller than a threshold is available. A configured condition for using a low-latency resource may include that delay-critical and/or high-priority data is available.

The WTRU may select a (e.g., one) low-latency resource for transmission. The WTRU may select the first low-latency resource for transmission (e.g., the first (e.g., temporally) low-latency resource in the set of low-latency resources, for example the low-latency resource in the set that is associated with an earliest available time. The WTRU may randomly select one low-latency resource within a configured window for transmission.

The WTRU may multiplex the configured ID and/or the allowed control and/or data units in a bit-sequence and/or transmit the configured ID and/or the allowed control and/or data units (e.g., the multiplexed configured ID and the allowed control and/or data units) in the selected low-latency resource.

One or more features described herein may enable a WTRU to reduce latency in transmission of control/data as the WTRU may use a low-latency resource directly without waiting for multiple rounds of signaling for SR/BSR. Spectrum efficiency of the system may be improved.

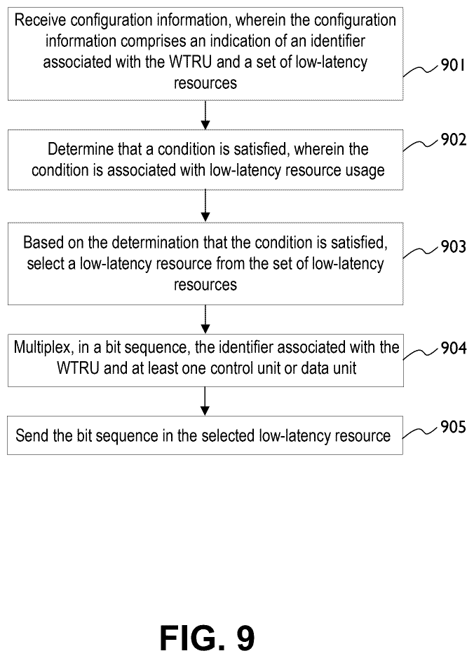

FIG. 9 illustrates an example WTRU configured to reduce latency in an uplink transmission, where one or more of the illustrated actions may be performed. At 901, the device may receive configuration information. The configuration information may include an indication of an identifier associated with the WTRU and a set of low-latency resources. At 902, the device may determine that a condition is satisfied. The condition may be associated with low-latency resource usage. At 903, the device may select a low-latency resource from the set of low-latency resources, based on the determination that the condition is satisfied. At 904, the device may multiplex, in a bit sequence, the identifier associated with the WTRU and at least one control unit or data unit. At 905, the device may send the bit sequence in the selected low-latency resource.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed:

1. A wireless transmit/receive unit (WTRU) comprising:
a processor configured to:
receive configuration information, wherein the configuration information comprises an indication of an identifier associated with the WTRU and a set of low-latency resources;
determine that a condition is satisfied, wherein the condition is associated with low-latency resource usage;
based on the determination that the condition is satisfied, select a low-latency resource from the set of low-latency resources;
multiplex, in a bit sequence, the identifier associated with the WTRU and at least one control unit or data unit; and
send the bit sequence in the selected low-latency resource.

2. The WTRU of claim 1, wherein the processor being configured to determine that the condition is satisfied comprises the processor being configured to determine that:
the configuration information indicates that units of a message type are to be sent in the selected low-latency resource, and the at least one control unit or data unit is of the message type;
a priority of the at least one control unit or data unit is above a first threshold;
a remaining delay budget associated with the at least one control unit or data unit is below a second threshold; or
a number of control units and data units in a buffer satisfies a third threshold.

3. The WTRU of claim 1, wherein the processor being configured to determine that the condition is satisfied comprises the processor being configured to determine at least one of:
at least one low-latency resource is available within a first window of time;
no non-low-latency resources are available prior to a next low-latency resource; or
no non-low-latency resources are available within a second window of time.

4. The WTRU of claim 1, wherein the selected low-latency resource is associated with a reference signal, wherein the processor is further configured to determine a measurement of the reference signal, and wherein the processor being configured to determine that the condition is satisfied comprises the processor being configured to determine that the measurement of the reference signal satisfies a threshold.

5. The WTRU of claim 1, wherein the processor is further configured to:
determine a threshold based on a remaining latency budget associated with the at least one control unit or data unit; and
determine a time duration between availability of the at least one control unit or data unit and a slot associated with the selected low-latency resource, wherein the processor being configured to determine that the condition is satisfied comprises the processor being configured to determine that the time duration is less than the determined threshold.

6. The WTRU of claim 1, wherein the processor being configured to select the low-latency resource from the set of low-latency resources comprises the processor being configured to:
select a temporally first low-latency resource from the set of low-latency resources; or
randomly select the low-latency resource from the set of low-latency resources.

7. The WTRU of claim 1, wherein the processor is further configured to:
receive a mapping between a transmission time of the bit sequence and a low-latency-response window of time;
determine the low-latency-response window of time based on the transmission time of the bit sequence; and
monitor for a low-latency-response during the low-latency-response.

8. The WTRU of claim 1, wherein the processor is further configured to:
receive an indication of a set of non-low-latency resources, wherein the set of non-low-latency resources are available prior to availability of low-latency resources; and
transmit, in a non-low-latency resource in the set of non-low-latency resources, an indication that the WTRU will send the bit sequence in the selected low-latency resource.

9. The WTRU of claim 1, wherein the processor is further configured to:
receive a mapping between the set of low-latency resources and a set of non-low-latency resources;
determine, based on the mapping, a non-low-latency resource associated with the selected low-latency resource; and
send a transmission in the non-low-latency resource, wherein the transmission in the non-low-latency resource implicitly indicates that the WTRU will send the bit sequence in the selected low-latency resource.

10. The WTRU of claim 1, wherein the selected low-latency resource is a first low-latency resource, the at least one control unit or data unit is a first at least one control unit or data unit, and the processor is further configured to:
determine a time duration between availability of a second at least one control unit or data unit and a slot associated with a second low-latency resource; and
based on a determination that the time duration is less than a threshold, send the second at least one control unit or data unit in a non-low-latency resource.

11. A method, performed by a wireless transmit/receive unit (WTRU), the method comprising:
receiving configuration information, wherein the configuration information comprises an indication of an identifier associated with the WTRU and a set of low-latency resources;
determining that a condition is satisfied, wherein the condition is associated with low-latency resource usage;
based on the determination that the condition is satisfied, selecting a low-latency resource from the set of low-latency resources;
multiplexing, in a bit sequence, the identifier associated with the WTRU and at least one control unit or data unit; and
sending the bit sequence in the selected low-latency resource.

12. The method of claim 11, wherein determining that the condition is satisfied comprises determining that:
the configuration information indicates that units of a message type are to be sent in the selected low-latency resource, and the at least one control unit or data unit is of the message type;
a priority of the at least one control unit or data unit is above a first threshold;
a remaining delay budget associated with the at least one control unit or data unit is below a second threshold; or
a number of control units and data units in a buffer satisfies a third threshold.

13. The method of claim 11, wherein determining that the condition is satisfied comprises determining at least one of:
at least one low-latency resource is available within a first window of time;
no non-low-latency resources are available prior to a next low-latency resource; or
no non-low-latency resources are available within a second window of time.

14. The method of claim 11, wherein the selected low-latency resource is associated with a reference signal, wherein the method further comprises determining a measurement of the reference signal, and wherein determining that the condition is satisfied comprises determining that the measurement of the reference signal satisfies a threshold.

15. The method of claim 11, wherein the method further comprises:
determining a threshold based on a remaining latency budget associated with the at least one control unit or data unit; and
determining a time duration between availability of the at least one control unit or data unit and a slot associated with the selected low-latency resource, wherein determining that the condition is satisfied comprises determining that the time duration is less than the determined threshold.

16. The method of claim 11, wherein selecting the low-latency resource from the set of low-latency resources comprises:
selecting a temporally first low-latency resource from the set of low-latency resources; or
randomly selecting the low-latency resource from the set of low-latency resources.

17. The method of claim 11, wherein the method further comprises:
receiving a mapping between a transmission time of the bit sequence and a low-latency-response window of time;
determining the low-latency-response window of time based on the transmission time of the bit sequence; and
monitoring for a low-latency-response during the low-latency-response.

18. The method of claim 11, wherein the method further comprises:
receiving an indication of a set of non-low-latency resources, wherein the set of non-low-latency resources are available prior to availability of low-latency resources; and
transmitting, in a non-low-latency resource in the set of non-low-latency resources, an indication that the WTRU will send the bit sequence in the selected low-latency resource.

19. The method of claim 11, wherein the method further comprises:
receiving a mapping between the set of low-latency resources and a set of non-low-latency resources;
determining, based on the mapping, a non-low-latency resource associated with the selected low-latency resource; and
sending a transmission in the non-low-latency resource, wherein the transmission in the non-low-latency resource implicitly indicates that the WTRU will send the bit sequence in the selected low-latency resource.

20. The method of claim 11, wherein the selected low-latency resource is a first low-latency resource, the at least one control unit or data unit is a first at least one control unit or data unit, and the method further comprises:
determining a time duration between availability of a second at least one control unit or data unit and a slot associated with a second low-latency resource; and
based on a determination that the time duration is less than a threshold, sending the second at least one control unit or data unit in a non-low-latency resource.
